(19) United States
(12) Patent Application Publication
(10) Pub. No.: US 2018/0272749 A1
(43) Pub. Date: Sep. 27, 2018

(54) INFORMATION PROCESSING DEVICE

(71) Applicants: Kazutaka YAMAMOTO, Kanagawa (JP); Daisuke TEZUKA, Tokyo (JP); Yukari SUMITA, Tokyo (JP)

(72) Inventors: Kazutaka YAMAMOTO, Kanagawa (JP); Daisuke TEZUKA, Tokyo (JP); Yukari SUMITA, Tokyo (JP)

(21) Appl. No.: 15/542,484

(22) PCT Filed: Mar. 14, 2016
(86) PCT No.: PCT/JP2016/001444

§ 371 Date: Jul. 10, 2017

(30) Foreign Application Priority Data
Mar. 18, 2015 (JP) 2015-055415
Jan. 8, 2016 (JP) 2016-002694

(51) Int. Cl. B41J 2/475; B41J 29/38

(52) U.S. Cl. CPC B41J 2/475; B41J 29/38

(57) ABSTRACT

An information processing device is connected to a first reading device to read a recording medium to generate first data, a writing device to write on the recording medium based on second data, and a second reading device to read the recording medium to generate third data. The information processing device includes a first retrieval unit to obtain the first data; an identifying unit to identify the recording medium based on the first data; a second retrieval unit to obtain, upon detecting that the writing device writes on the recording medium, the third data; a determination unit to determine whether the second data differs from the third data; a calculation unit to calculate a number of times of writing on the recording medium; a storage unit to store the calculation value; and an evaluation unit to evaluate the recording medium based on the calculation value.

### TECHNICAL FIELD

The present invention relates to an information processing device, an information processing system, an information processing method, and a program.

### BACKGROUND ART

A method of writing information on a container has been known. In the method, a label is attached to a container, and an address and a product name are written on the label, or combinations of addresses and product names are written on the label. If the label is formed of thermo-sensitive paper, upon applying heat to a portion of the label, the color of the portion of the label is changed. By using this fact, text, a symbol, and/or a combination thereof can be written on the label by applying heat. In this manner, a container to which the label is attached can be managed.

For a writing function of writing information on a sheet of rewritable paper, a method of quickly and easily recovering from a failure of the writing function has been known (cf. Patent Document 1 (Japanese Unexamined Patent Publication No. 2014-184713), for example). According to this method, heat is applied to a sheet of rewritable paper by irradiating a laser beam onto the sheet of rewritable paper, and thereby identification information is written on the sheet of rewritable paper. Then, in response to detecting that the written identification information is read, a determination is made as to whether the read identification information matches the written identification information. If it is detected that the read identification information does not match the written identification information, recovery information is created, and the failure of the writing function can be quickly and easily recovered from.

### SUMMARY OF INVENTION

### Technical Problem

However, according to the above-described method, even if information for managing a label is written in the label, it is possible that the written information is deleted in the label. Thus, a number of times of writing the information on a recording medium (which is referred to as a number of times of writing, hereinafter) may not be found. It may be difficult to find the number of times of writing, and to manage the recording medium.

There is a need for an information processing device that facilitates managing a recoding medium.

### Solution to Problem

According to an aspect of the present invention, there is provided an information processing device configured to connect to a first reading device configured to execute reading of a recording medium attached to a container to generate first data, a writing device configured to execute writing on the recording medium based on second data, and a second reading device configured to execute reading of the recording medium to generate third data. The information processing device includes a first retrieval unit configured to obtain the first data; an identifying unit configured to identify the recording medium based on the first data; a second retrieval unit configured to obtain, upon detecting that the writing device executes writing on the recording medium based on the second data, the third data; a determination unit configured to determine whether the second data differs from the third data; a calculation unit configured to calculate a calculation value including a number of times of writing on the recording medium or a ratio of a number of times of determining, by the determining unit, that the second data differs from or is identical to the third data with respect to the number of times of writing; a storage unit configured to store the calculation value, while associating the recording medium identified by the identifying unit with the calculation value; and an evaluation unit configured to evaluate the recording medium based on the calculation value.

According to another aspect of the present invention, there is provided an information processing device configured to connect to a reading device configured to execute reading of a recording medium attached to a container to generate first data, and a writing device configured to execute writing on the recording medium. The information processing device includes a first retrieval unit configured to obtain the first data; an identifying unit configured to identify the recording medium based on the first data; a calculation unit configured to calculate a calculation value including a number of times of writing for a case in which next writing is executed on the recording medium; a storage unit configured to store the calculation value, while associating the recording medium identified by the identifying unit with the calculation value; and an evaluation unit configured to evaluate the recording medium based on the calculation value.

### Advantageous Effects of Invention

According to an embodiment, an information processing device that facilitates managing a recoding medium can be provided.

### BRIEF DESCRIPTION OF DRAWINGS

FIG. 1 is a configuration diagram illustrating an example of an entire configuration of an information processing system according to an embodiment of the present invention;

FIG. 2 is a diagram illustrating an example of a recording medium according to the embodiment;

FIG. 3 is a block diagram illustrating an example of a hardware configuration of a writing device according to the embodiment;

FIG. 4 is a block diagram illustrating an example of a hardware configuration of a whole controller included in the writing device according to the embodiment;

FIG. 5 is a block diagram illustrating an example of a hardware configuration of an information processing device according to the embodiment;

FIG. 6 is a block diagram illustrating an example of a hardware configuration of a first reading device and a second reading device according to the embodiment;

FIG. 7 is a flowchart illustrating an example of a whole process by the information processing system according to the embodiment;

FIG. 8 is a diagram illustrating an example of a case where writing, in the whole process by the information processing system according to the embodiment, is successful;

FIG. 9 is a diagram illustrating an example of a case where writing, in the hole process by the information processing system according to the embodiment, has failed;

FIG. 10 is a flowchart illustrating an example of a re-inputting process by the information processing system according to the embodiment;

FIG. 11 is a flowchart illustrating an example of a whole process by the information processing system according to another embodiment; and

FIG. 12 is a functional block diagram illustrating an example of a functional configuration of the information processing system according to the embodiment.

### DESCRIPTION OF EMBODIMENTS

An embodiment of the present invention is described below.

### An Embodiment

(An Example of a Whole Configuration)

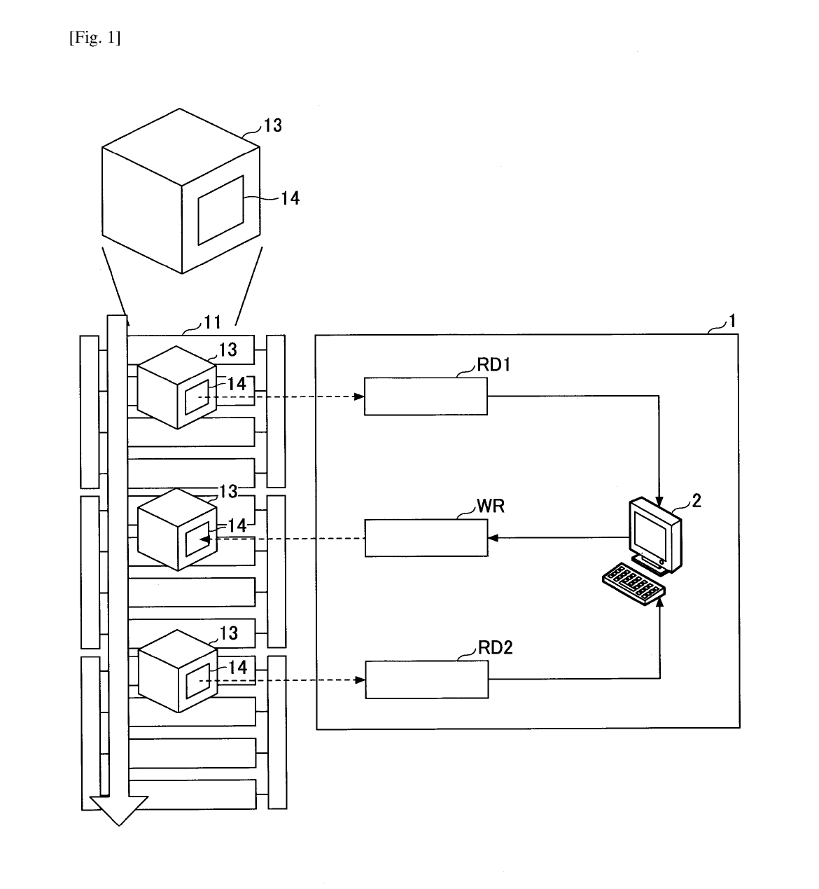

FIG. 1 is a configuration diagram illustrating an example of a whole configuration of an information processing system 1 according to the embodiment of the present invention. Specifically, the information processing system 1 includes a reader (RD) 1 as an example of a first reading device; a laser writing device (WR) as an example of a writing device; and a reader (RD) 2 as an example of a second reading device. Additionally, the information processing system 1 includes a personal computer (PC) 2 as an example of an information processing device. In the information processing system 1, the PC 2 is connected to each of the RD 1, the laser writing device WR, and the RD 2.

Further, as depicted, it is assumed that a container, such as a corrugated cardboard box, a wooden box, or a plastic case, is conveyed by a conveyance device, such as a conveyor 11. In an example described below, it is assumed that the container to be conveyed is a container 13 in FIG. 1. Further, in the following example, it is assumed that the container 13 is conveyed on the conveyor 11 from an upstream position where the RD 1 is disposed to a downstream position where the RD 2 is disposed through a position where the laser writing device WR is disposed.

The container 13 includes, for example, a thermo-sensitive recording medium 14 that changes color depending on temperature so as to display an address of a product, a product name, a product number, an addressee's name, and/or a combination thereof (which is called the address, hereinafter). In the information processing system 1, information is written in the thermo-sensitive recording medium 14, and information is read out from the thermo-sensitive recording medium 14. Here, the thermo-sensitive recording medium 14 may be a label or a sheet of rewritable paper.

The thermo-sensitive recording medium 14 may be adhered to the container 13. Alternatively, the thermo-sensitive recording medium 14 may be detachably attached to the container 13. After information is written on the thermo-sensitive recording medium 14, the thermo-sensitive recording medium 14 may be recognized as a label by a person. In the conveyor 11, the laser writing device WR is disposed at a position facing the thermo-sensitive recording medium 14. In response to detecting that the container 13 is passing through the vicinity of the laser writing device WR, for example, by using a sensor, the laser writing device WR writes, on the thermo-sensitive recording medium 14, a character, a number, a figure, a symbol, a barcode, a two-dimensional barcode, or a combination thereof that indicates the address.

Note that the two-dimensional code may be, for example, QR code (registered trademark), the two-dimensional code of a matrix type (e.g., DataMatrix), or the two-dimensional code of a stuck type (e.g., PDF 417).

The information processing system 1 may further include a server or an information processing device, such as a personal computer (PC) 2. The PC 2 may be formed of a plurality of computers.

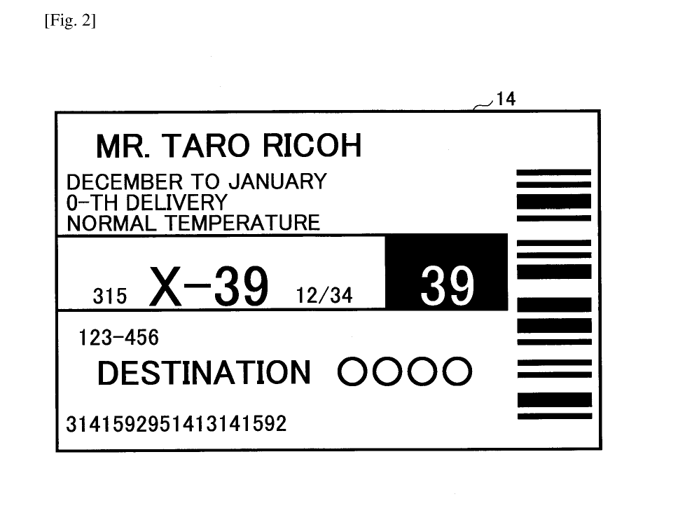

FIG. 2 is a diagram illustrating an example of the thermo-sensitive recording medium 14 according to the embodiment.

The laser writing device WR (cf. FIG. 1) writes the character, such as the characters illustrated in FIG. 2, on the thermo-sensitive recording medium 14. Specifically, the laser writing device WR writes the character by irradiating a laser beam onto the thermo-sensitive recording medium 14. Here, the laser beam may preferably be a spot light beam that is condensed by a lens, so that complicated characters can be processed. Thus, the laser writing device WR that emits the laser beam controls a position at which the laser beam is irradiated, so that a stroke, such as characters, can be followed by a spot light beam.

(Hardware Configuration of the Laser Writing Device)

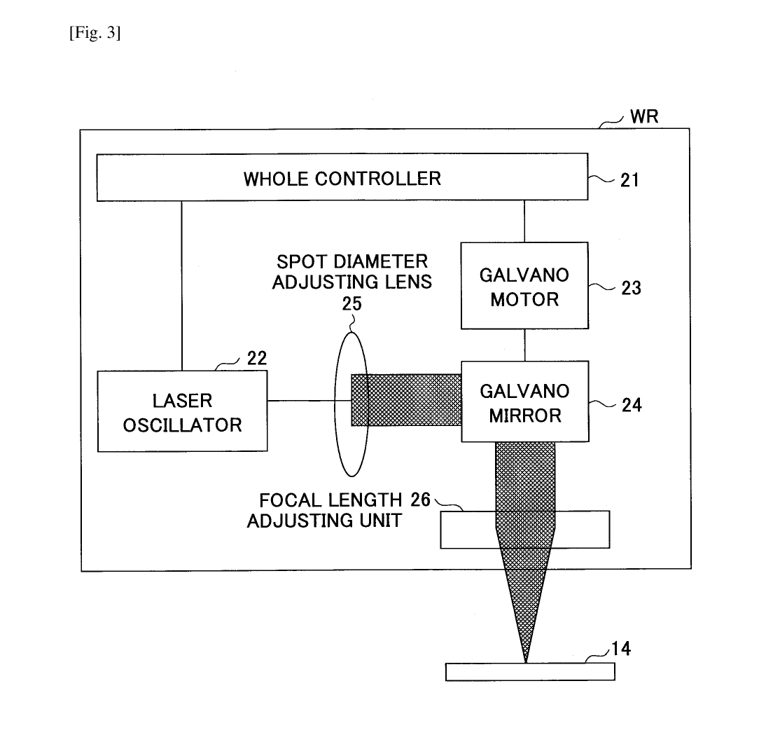

FIG. 3 is a block diagram illustrating an example of a hardware configuration of the laser writing device WR according to the embodiment of the present invention. Specifically, the laser writing device WR may include a whole controller 21; a laser oscillator 22; a galvano motor 23; a galvano mirror 24; a spot diameter adjusting lens 25; and a focal length adjusting unit 26.

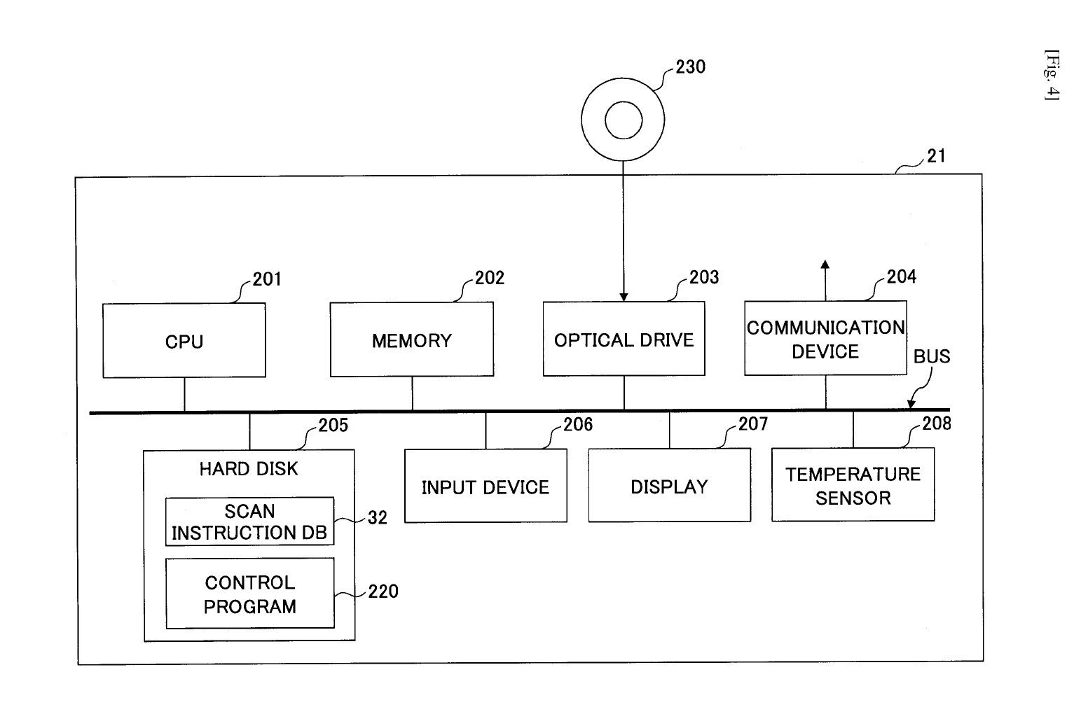

FIG. 4 is a block diagram illustrating an example of a hardware configuration of the whole controller 21 included in the laser writing device WR according to the embodiment. Specifically, the whole controller 21 may include a central processing unit (CPU) 201; a memory 202; an optical drive 203; a communication device 204; a hard disk 205; an input device 206; a display 207; and a temperature sensor 208. Further, the hard disk 205 stores a scan instruction data base (DB)32 that stores a scan instruction for writing the text. Further, the hard disk 205 stores a control program 220 for controlling the laser oscillator 22 (FIG. 3) and the galvano motor 23 (FIG. 3) in accordance with the scan instruction.

The CPU 201 reads out the control program 220 from the hard disk 205 and executes the control program 220 so as to write the character on the thermo-sensitive recording medium 14 (FIG. 1). Namely, the CPU 201 is a controller and a processor.

The memory 202 is a volatile memory, such as a dynamic random access memory (DRAM). The memory 202 can be a work area for the CPU 201 to execute the control program 220.

The optical drive 203 is configured so that a storage medium 230 can be detachably attached to the whole controller 21. The optical drive 203 can be used for reading out data from the storage medium 230, and for writing data in the storage medium 230.

The communication device 204 may be, for example, an Ethernet (registered trademark) card, a serial communication device (e.g., a Universal Serial Bus (USB) device), an IEEE 1394-based device, or a Bluetooth (registered trademark) device. Further, the communication device 204 can be used for transmitting data to or receiving data from an external device.

The hard disk 205 is an example of an auxiliary storage device for storing data, parameters, and/or one or more programs, which are to be used by the whole controller 21.

The input device 206 may be, for example a mouse and a keyboard. The input device 206 is a device for a user to input an instruction for controlling the laser writing device WR (FIG. 3).

The display 207 is a user interface for displaying, for example, a graphical user interface (GUI) screen with a resolution and a number of colors based on screen information instructed by the control program 220, for example. The display 207 may display, for example, an input field for inputting the character, which is to be written on the thermo-sensitive recording medium 14.

The temperature sensor 208 periodically measures environmental temperature of the laser writing device WR, and the temperature sensor 208 outputs the measured temperature to the CPU 201.

The control program 220 may be distributed in a state where the control program 220 is stored in the storage medium 230. The control program 220 may be read out from the storage medium 230, and the control program 220 may be installed in the hard disk 205. Alternatively, the control program 220 may be downloaded from, for example, a server that is connected to the whole controller 21 through a network.

The storage medium 230 is a detachable and portable non-volatile memory, such as a DVD-ROM, a Blue-ray disk, an SD (registered trademark) card, a multimedia card, or a xD card.

Referring back to FIG. 3, the laser oscillator 22 is a semiconductor laser (a laser diode (LD). Alternatively, the laser oscillator 22 may be a gas laser, a solid state laser, or a liquid laser, for example.

The galvano motor 23 may be, for example, servo motors for controlling a direction of a reflection surface of the galvano mirror 24 with two axes.

The galvano mirror 24 is an example of a direction control mirror. The galvano mirror may be another mirror as long as the direction can be controlled. For example, the galvano mirror 24 may be a Micro Electro Mechanical Systems (MEMS) mirror.

The spot diameter adjusting lens 25 is a lens for magnifying a spot diameter of a laser beam. The focal length adjusting unit 26 is a lens for adjusting the focal distance by converging a laser beam. Further, the focal length adjusting unit 26 adjusts the focal distance depending on the distance from the laser oscillator 22, which is a light source, to the position on the thermo-sensitive recording medium 14 at which the laser beam is irradiated. Here, it can be said that the focal length adjusting unit 26 adjusts the focal length depending on the distance from the laser writing device WR because the position of the laser oscillator 22 is fixed.

Note that the writing device is not limited to the writing device that emits a laser beam, such as the laser writing device WR. For example, the writing device may be, for example, a label printer or a thermal printer that executes printing by causing a recording medium to develop color by pressing a heated head to the recording medium. Alternatively, the writing device may be a laser process machine that engraves a recording medium by irradiating a laser beam onto the recording medium.

(Example of Recording Medium)

The thermo-sensitive recording medium 14 (FIG. 2) includes, for example, four layers in a depth direction from the surface, which are a protection layer, a recording layer including a reversible thermo-sensitive recording film, a base material layer, and a back coat layer. Further, the thermo-sensitive recording medium 14 is formed to have flexibility and a certain extent of a strength property, so that the thermo-sensitive recording medium 14 can be repeatedly used. The thermo-sensitive recording medium 14 may be referred to as a thermo-sensitive paper sheet. However, the thermo-sensitive recording medium 14 may not be formed of only a plant fiber. The thermo-sensitive recording medium 14 may not include a plant fiber.

In a part of the thermo-sensitive recording medium 14, a rewritable display area is formed, as a rewritable reversible area. Such a thermo-sensitive recording medium 14 may be referred to as a rewritable paper sheet. Further, the rewritable display area is formed of a reversible thermo-sensitive recording medium, such as a thermo-chromic film. The types of the reversible thermo-sensitive recording media include a type of the reversible thermo-sensitive recording medium such that a degree of transparency reversibly changes depending on temperature; and a type of the reversible thermo-sensitive recording medium such that a color tone reversibly changes depending on temperature.

An example is described below where the thermo-sensitive recording medium 14 includes a thermo-chromic film such that the color tone reversibly changes depending on temperature, and that achieves a rewritable property by including a leuco dye and a developer in the recording layer.

For example, when a part of or all the thermo-sensitive recording medium 14 is heated from a decolorized state to above a melting point (e.g., approximately 180° C.), the heated portion is rapidly cooled from a melting state where the leuco dye and the developer of the thermo-sensitive recording medium 14 are mixed. Thus, the color of the part of or all the thermo-sensitive recording medium 14 changes to black color, for example. In this case, in the thermo-sensitive recording medium 14, the dye and the developer are condensed while the dye and the developer are bonded. In this manner, in the thermo-sensitive recording medium 14, the dye and the developer form a state where the dye and the developer are systematically collected to some extent. Thus, the state is fixed where the color of the thermo-sensitive recording medium 14 is changed.

Whereas, when the part of or all the thermo-sensitive recording medium 14 is heated to a temperature at which the colorized state is not melted (e.g., from 130° C. to 170° C.), the colorized collected state collapses, and the developer is crystallized along and separated, so that the state becomes the decolorized state. Namely, when the part of or all the thermo-sensitive recording medium 14 is heated to the temperature at which the colorized state is not melted, the character that is written on the thermo-sensitive recording medium 14 is deleted. Further, the leuco dye is color-less or light-colored dye precursor. The leuco dye is not particularly limited, and the leuco dye can be suitably selected from known materials.

Note that the color change includes not only appearance of a visible shape with color information, but also appearance of of a shape without color information. For example, the color change includes the fact that the white thermo-sensitive recording medium 14 changes to black, and the fact that the black thermo-sensitive recording medium 14 changes to white.

Further, it is not necessary that the thermo-sensitive recording medium 14 is rewritable. The thermo-sensitive recording medium 14 may be a write-once type thermo-sensitive recording medium (i.e., a type of thermo-sensitive recording medium such that once the character is written, the character can not be deleted).

Here, the size of the thermo-sensitive recording medium 14 is A4 size, for example. However, the size of the thermo-sensitive recording medium 14 may be suitably adjusted.

Each of the thermo-sensitive recording medium 14 and the container 13 (FIG. 1) has a service life, which depends on the number of times writing. It is assumed that, upon expiration of the service life, each of the thermo-sensitive recording medium 14 and the container 13 is replaced or repaired.

Furthermore, the target to be written on is not limited to the recording medium. For example, if the writing device WR is a laser process machine, the target to be written on may be a product which is to be engraved.

(Example of the Hardware Configuration of the Information Processing Device)

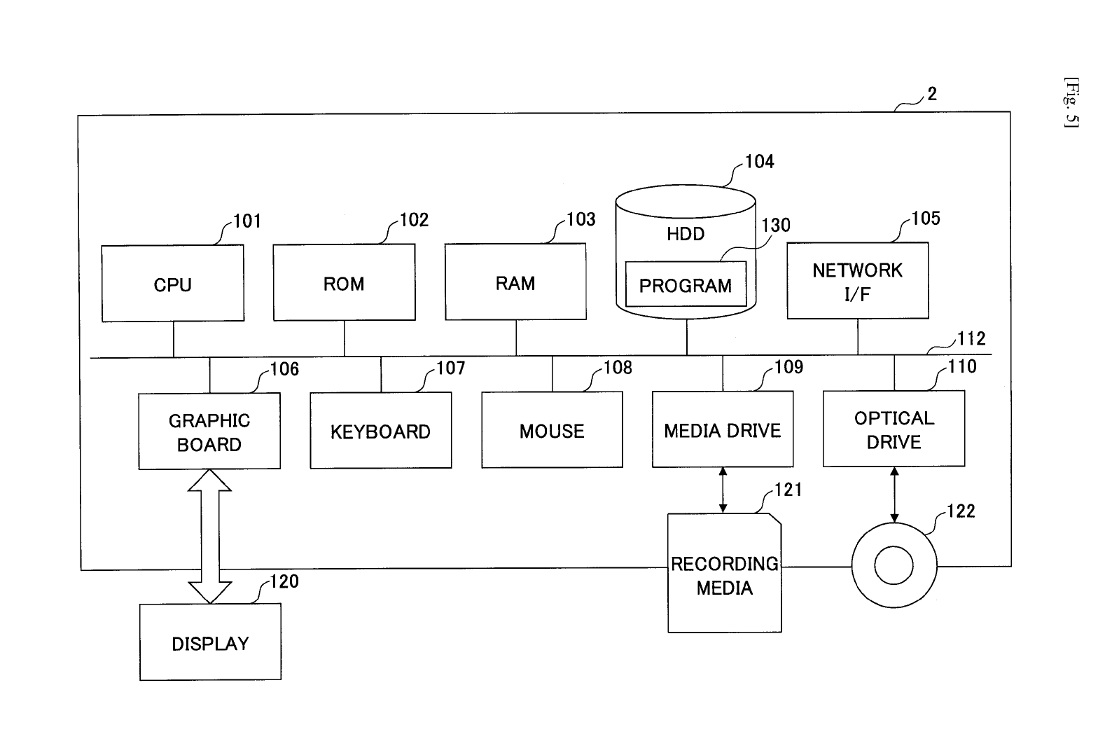

FIG. 5 is a block diagram illustrating an example of a hardware configuration of the information processing device 2 according to the embodiment. As the PC 2, a general-purpose information processing device can be used. Here, examples of the information processing device 2 include a personal computer (PC), a work station, a tablet PC, a server, a smartphone, and so forth. However, the information processing device 2 may be referred to by a different name. In the following, an example is described where the information processing device 2 is a personal computer.

The PC 2 may include, for example, a CPU 101; a read-only memory (ROM) 102; a random access memory (RAM) 103; a hard disk drive (HDD) 104; a network interface (I/F) 105; a graphic board 106; a keyboard 107; a mouse 108; a media drive 109; and an optical drive 110.

The CPU 101 controls overall operation of the PC 2 by executing a program 130 stored in the HDD 104. Namely, the CPU 101 is a controller and a processor.

The ROM 102 stores, for example, an initial program loader (IPL) and static data.

The RAM 103 is an example of a main storage device that can be used by the CPU 101 as a work area for executing the program 130.

The HDD 104 stores the program 130 and an operating system (OS) that are to be executed by the CPU 101. The program 130 is the program for generating a scan instruction to the laser writing device WR from information on a shape of a figure, such as peaks and frame lines. Namely, based on the program 130, the PC 2 transmits, to the laser writing device WR, data indicating the character, which is to be written by the laser writing device WR. Subsequently, upon receiving the data indicating the character, the laser writing device WR generates the scan instruction from the information on the shape of the figure, such as the peaks and the frame lines, so as to write the character. Here, the PC 2 may generate a part of or all the scan instruction, and the PC 2 may transmit generated data indicating the scan instruction to the laser writing device WR.

The network I/F 105 may be, for example, an Ethernet (registered trademark) card for establishing a connection to a network, and the network I/F 105 mainly executes a layer 1 process and a layer 2 process. Here, a process above the layer 3 can be executed by a protocol stack and program of the transmission control protocol/Internet Protocol (TCP/IP), which are included in the OS.

The graphic board 106 parses a drawing command that is written by the CPU 101 in a video RAM, and the graphic board 106 displays various types of information, such as a window, a menu, a cursor, a character, or an image, on the display 120.

The keyboard 107 includes a plurality of keys for a user to input characters, numbers, and instructions. The keyboard 107 receives operation by a user, and the keyboard 107 reports the operation to the CPU 101. Similarly, the mouse 108 receives operations by a user, such as operation to move a cursor, operation to select a menu item, and operation related to processing details.

The media drive 109 controls a process of reading out data from or writing (storing) data in the recording medium 121, such as a flash memory.

The optical drive 110 controls a process of reading out various types of data from or writing various types of data in the optical medium 122, such as a CD-R and a DVD-RW, as an example of a detachable recording medium. Further, the PC 2 includes a bus line 112, such as an address bus and a data bus, for electrically connecting the hardware components.

The program 130 can be recorded in the computer readable recording medium 121 or the computer readable optical medium 122 as a file in a installable format or in an executable format, and the program 130 can be distributed by distributing the recording medium 121 or the optical medium 122. Alternatively, the program 130 may be downloaded from a server to the PC 2 as a file in an installable format or a file in an executable format.

(Examples of Hardware Configurations of the First Reading Device and the Second Reading Device)

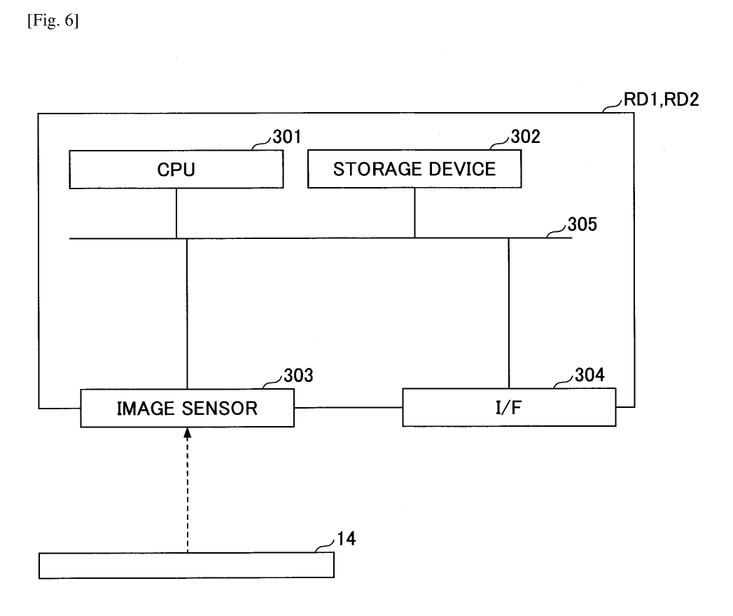

FIG. 6 is a block diagram illustrating an example of a hardware configuration of the first reading device RD 1 and a hardware configuration of the second reading device RD 2 according to the embodiment. For example, the hardware configuration of the reader RD 1 may be the same as the hardware configuration of the reader RD 2. The example of the hardware configuration of the reader RD 1 is described below.

The reader RD 1 may be an image processing device including a barcode reader, or a camera; or the reader RD 1 may be a system in which the barcode reader and the camera are combined. Note that the reader RD 1 may be changed depending on a type of the character written on the thermo-sensitive recording medium 14.

The reader RD 1 may include, for example, a CPU 301; a storage device 302; an image sensor 303; and an I/F 304. Further, the hardware components included in the reader RD 1 are connected by a bus 305.

The CPU 301 controls overall operation of the reader RD 1 by executing a program stored in the storage device 302. Namely, the CPU 301 is a controller and a processor.

The storage device 302 is a memory, for example. The storage device is an example of a main storage device that can be used by the CPU 301 as a work area for executing a program. Here, the storage device 302 may include an auxiliary storage device, such as a hard disk drive.

The image sensor 303 can be a camera, for example. The image sensor 303 generates image data, which represents the character written on the thermo-sensitive recording medium 14.

The I/F 304 may be, for example, a connector and a processing integrated circuit (IC) for establishing a connection to an external device (e.g., PC 2) through a network or a cable (e.g. RS-232C).

The reader RD 1 analyzes the character written on the thermo-sensitive recording medium 14 by applying an optical character recognition (OCR) process to the image data generated by the image sensor 303, for example. Next, the RD 1 generates text data or image data representing the character written on the thermo-sensitive recording medium 14, and the RD 1 transmits the generated text data or image data to the external device (e.g., the PC 2) through the I/F 304.

(Example of the Whole Process)

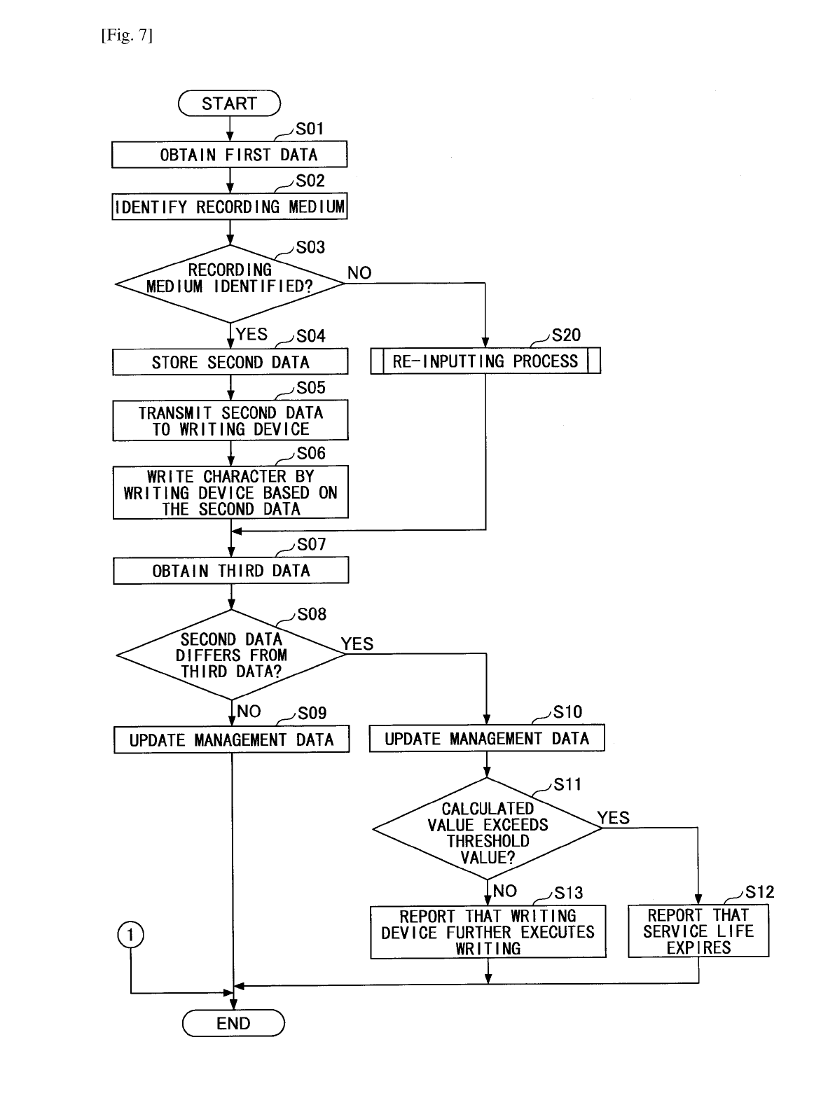

FIG. 7 is a flowchart illustrating an example of the whole process executed by the information processing system 1 according to the embodiment. Note that the process illustrated in FIG. 7 is an example of a process that can be executed by the information processing system 1 (FIG. 1) for each thermo-sensitive recording medium 14 (FIG. 1).

For example, suppose that the thermo-sensitive recording medium 14 is adhered to the container 13 (FIG. 1); that the character indicating, for example, an address is written on the thermo-sensitive recording medium 14; and that the container 13 is shipped from a factory. Further, suppose that, after shipping, a package packed in the container 13 is collected; and that the container 13 is returned to the factory. In the following, an example is described where the container 13 is returned to the factory, and the character indicating, for example, the next address is written on the thermo-sensitive recording medium 14 by the information processing system 1, as illustrated in FIG. 1.

(Example of Obtaining the First Data (Step S01))

At step S01, the PC 2 (FIG. 1) obtains the first data from the reader RD 1 (FIG. 1). Specifically, the reader RD 1 reads the character written on the thermo-sensitive recording medium 14, which is attached to the container 13 conveyed by the conveyor 11 (FIG. 1). Here, it is assumed that the character representing the identification (ID) for identifying the thermo-sensitive recording medium 14 is written on the thermo-sensitive recording medium 14. Subsequently, the reader RD 1 generates ID data (which is referred to as the first ID data, hereinafter) representing the ID based on the read character, and the reader RD 1 transmits the generated ID data to the PC 2.

For example, if the ID is written on the thermo-sensitive recording medium 14 as a bar code, the reader RD 1 reads the barcode, and the reader RD 1 reads the value indicated by the barcode as the ID. In this case, the reader RD 1 generates the first ID data representing the ID read from the barcode, and the reader RD 1 transmits the first ID data to the PC 2.

(Example of Identifying the Recording Medium (Step S02))

At step S02, the PC 2 identifies the thermo-sensitive recording medium 14. Specifically, first, the PC 2 stores the data shown below (Table 1) as an example of write management data.

TABLE 1

| DTNo | Written content | . . . | ID |
|---|---|---|---|
| 1 | Hanako Ricoh | . . . | aaa |
| 2 | Yukiko Ricoh | . . . | bbb |
| 3 | Taro Ricoh | . . . | ccc |
| . | . | . | . |
| . | . | . | . |
| . | . | . | . |

Here, “DTNo” is a serial number for identifying data. For each data item, the “DTNo” is assigned so that a number of a data item does not overlap another number of another data item.

“Written content” is data indicating the character to be written on the thermo-sensitive recording medium 14. For example, a destination is input as the “Written content.” Note that a plurality of types of the “Written contents” may be input to the PC 2. The above-described Table 1 is an example where, in addition to the ID, the character indicating the destination is written as the “Written content.”

“ID” indicates an ID for identifying the thermo-sensitive recording medium 14. Note that “ID” is data that can be read from the character written on the thermo-sensitive recording medium 14. For each “ID,” the corresponding character is assigned, so that the IDs are not overlapped in a predetermined time period.

Namely, on each thermo-sensitive recording medium 14, for example, the data corresponding to one row of Table 1 is written, among the items of the write management data shown above (Table 1). Additionally, it is assumed that, among the data items shown above (Table 1), the data items are written on the corresponding thermo-sensitive recording media 14 in an ascending order of the value of “DTNo.” Namely, the write management data is the data for maintaining the contents, which are to be written on the corresponding thermo-sensitive recording media 14.

Furthermore, the PC 2 stores, for example, the data (which is referred to as “management data”) shown below (Table 2).

TABLE 2

| | | | First | Second |
|---|---|---|---|---|
| ITNo | ID | Second data | calculated value | calculated value |
| 1 | aaa | | 40% | 10 times |
| 2 | bbb | | 60% | 100 times |
| 3 | ccc | | 60% | 5 times |
| . | . | . | . | . |
| . | . | . | . | . |
| . | . | . | . | . |

Here, the “ITNo” is a serial number for identifying each data item included in the management data. For each data item, the “ITNo” is assigned, so that a number of a data item does not overlap another number of another data item.

The “ID” is identification for identifying the thermo-sensitive recording medium 14. The “ID” associates data of calculated values with the the thermo-sensitive recording medium 14.

The “Second data” represents contents of the second data written on the thermo-sensitive recording medium 14. In the following, an example is described where an ID that is newly written on the thermo-sensitive recording medium 14 is input as the “Second data.” The field of the “Second data” is a work area that can be used during writing. In the following, the example is described where the second data indicates the ID to be written (which is referred to as the “second ID data,” hereinafter). Here, the second data may include, in addition to the ID, a destination, for example.

The “first calculated value” and the “second calculated value” represent examples of the calculated values. Specifically, the “first calculated value” is an example of a value indicating a ratio of the number of times of failing to write on the thermo-sensitive recording medium 14 with respect to the number of times of writing. Note that the above-described Table 2, the “first calculated value” is an example where the ratio is represented by a percentage.

Further, the “second calculated value” is an example of the number of times of writing.

Here, the number of times of writing is a number of times of writing on the thermo-sensitive recording medium 14 by the writing device, for example. In the following description, the example is described where the number of times of writing is the number of times of executing writing. Note that the number of times of writing can be counted at a timing at which the writing device writes on the thermo-sensitive recording medium 14. Alternatively, the number of times of writing can be counted at another timing.

For example, the number of times of writing may be a value that can be estimated from information on a number of times, such as a number of times of arrival of the container. Namely, the number of times of writing may be a number of times of arrival of the container that is counted at a timing at which a container, to which the thermo-sensitive recording medium 14 is adhered, arrives at a work area where the writing device writes the character on the thermo-sensitive recording medium 14 (e.g., the position where the container 13 is depicted in FIG. 1). Alternatively, the number of times of writing may be a number of times of placing, by an operator, the container on the conveyance device that conveys the container to the work area where the writing device writes the character on the thermo-sensitive recording medium 14.

Further, the number of times of writing may preferably be calculated from a value that is counted at a timing at which the writing device writes the character on the thermo-sensitive recording medium 14. However, the number of times of writing may be calculated from another value with which the number of times of writing can be calculated.

In the management data, as described above (Table 2), for each thermo-sensitive recording medium 14, the calculated values are associated with the thermo-sensitive recording medium 14 by the “ID,” and the calculate values are stored. Note that, upon the thermo-sensitive recording medium 14 being replaced, each data item included in the management data may preferably be reset. After each data item included in the management data is reset, among the data items included in the management data, the calculated values are set to the initial values (e.g., “0”), for example.

Alternatively, after each data item included in the management data is reset, the PC 2 may delete data written in the row corresponding to the thermo-sensitive recording medium 14 from the management data. Further, upon detecting that the thermo-sensitive recording medium 14 is replaced with a new thermo-sensitive recording medium 14, the management data may be updated to be data corresponding to the new thermo-sensitive recording medium 14. Further, the management data may store one of the “first calculated value” and the “second calculated value” as the calculated value. Furthermore, the management data may include three or more calculated values or another type of data.

The “first calculated value” may be a ratio of the number of times of successfully writing on the thermo-sensitive recording medium 14 with respect to the number of times of writing.

Namely, the management data is data for maintaining contents that are written by the writing device, for example.

At step S02, the PC 2 searches for the ID that is the same as the ID represented by the ID data obtained at step S01 from the “ID” of the management data described above (Table 2). For example, upon detecting that the ID is “ccc,” the PC 2 identifies that the thermo-sensitive recording medium 14 is a recording medium corresponding to the data where the “ITNo” is “3.” Whereas, upon detecting that the above-described Table 2 does not include “ccc” as the “ID,” the PC 2 determines that the thermo-sensitive recording medium 14 is not identifiable.

(Determination as to Whether the Recording Medium is Identified (Step S03))

At step S03, the PC 2 determines whether the thermo-sensitive recording medium 14 is identified at step S02. Specifically, upon detecting that the ID is “ccc,” and that the above-described management data in Table 2 includes “ccc” as “ID,” the PC 2 determines that the thermo-sensitive recording medium 14 is identified. Whereas, upon detecting that the ID is “ccc,” and that the above-described management data in Table 2 does not include “ccc” as “ID,” the PC 2 determines that the thermo-sensitive recording medium 4 is not identified.

Upon determining, by the PC 2, that the thermo-sensitive recording medium 14 is identified (YES at step S03), the process of the PC 2 proceeds to step S04. Whereas, upon determining, by the PC 2, that the thermo-sensitive recording medium 14 is not identified (NO at step S03), the process of the PC 2 proceeds to step S20.

(Example of Storing the Second Data (Step S04))

At step S04, the PC 2 determines the second data indicating the character to be written on the thermo-sensitive recording medium 14 by the laser writing device WR (FIG. 1), and the PC 2 associates the second data and the identified thermo-sensitive recording medium 14, and stores the second data.

At step S04, the PC 2 associates the thermo-sensitive recording medium 14 identified at step S02 with the “ID” to be written, and the PC 2 stores the “ID.” Namely, the PC 2 registers the “ID” to be written in the management data as described below (Table 3).

TABLE 3

| | | | First | Second |
|---|---|---|---|---|
| ITNo | ID | Second data | calculated value | calculated value |
| 1 | aaa | | 40% | 10 times |
| 2 | bbb | | 60% | 100 times |
| 3 | ccc | *** | 60% | 5 times |
| . | . | . | . | . |
| . | . | . | . | . |
| . | . | . | . | . |

The above-described Table 3 differs from the above-described Table 2 in a point that, in Table 3, “***” is registered as the “second data” in the row for which the “ITNo” is “3.” Note that, “***” is an example of a new ID that is newly written on the thermo-sensitive recording medium 14.

Namely, at step S04, the PC 2 associates the thermo-sensitive recording medium 14 identified at step S02 with the second ID data indicating the character to be written on the thermo-sensitive recording medium 14, and stores the second ID data, as described above (Table 3).

(Example of Transmitting the Second Data to the Writing Device (Step S05))

At step S05, the PC 2 transmits the second ID data to the laser writing device WR.

Specifically, it is assumed that the PC 2 has the data described below (Table 4).

TABLE 4

| | | | | | |
|---|---|---|---|---|---|
| RQNo | 1 | 2 | 3 | . . . | N |
| ITNo | | | | . . . | |

Here, “RQNo” is a serial number identifying a corresponding data item. For each data item, the “RQNo” is assigned so that a number of a data item does not overlap another number of another data item.

The “ITNo” is a work area for assigning the “ITNo” of the management data described above (Table 3).

The data described above (Table 4) has a queue structure. Namely, the PC 2 transmits the second ID data identified by the “ITNo” to the laser writing device WR in an order of the “RQNo” described above (Table 4). Thus, the laser writing device WR executes writing on the thermo-sensitive recording medium 14 based on the second ID data that is transmitted in the order of the “RQNo.” The number of the “ITNo” is not specifically limited. However, it is desirable that the number of the “ITNo” is greater than the number of the containers placed on the conveyor 11 (FIG. 1).

For example, if data is stored in the work area where “RQNo” is “1,” and data is stored in the work area where “RQNo” is “2,” the PC 2 adds “3” (“ITNo”), which is stored at step S04, to the work area where “RQNo” is “3.” In this case, the second ID data representing “***” is transmitted to the laser writing device WR third.

Note that the above-described (Table 4) data may be maintained by the laser writing device WR. In this case, the PC 2 may transmit the second ID data in the order of writing on the thermo-sensitive recording medium 14 by the laser writing device WR, so that the laser writing device WR writes the data in the order described above (Table 4).

(Example of Writing, by the Writing Device, the Character Based on the Second Data (Step S06))

At step S06, the laser writing device WR writes the character on the thermo-sensitive recording medium 14 based on the second ID data.

Note that the laser writing device WR may delete the character that is written on the thermo-sensitive recording medium 14. Here, the character may be deleted by a device other than the laser writing device WR.

(Example of Obtaining the Third Data (Step S07))

At step S07, the PC 2 obtains the ID data (which is referred to as the “third ID data,” hereinafter), as an example of the third data, from the reader RD 2 (FIG. 1). Specifically, the reader RD 2 reads the character representing the ID that is written on the thermo-sensitive recording medium 14 attached to the container 13, which is conveyed by the conveyor 11 (FIG. 1). Subsequently, the reader RD 2 generates the third ID data based on the read character, and the reader RD 2 transmits the generated third ID to the PC 2.

(Example of Determining Whether the Second Data Differs from the Third Data (Step S08))

At step S08, the PC 2 determines whether the second data differs from the third data.

Specifically, at step S06, the laser writing device WR writes the character representing the new ID “***” on the thermo-sensitive recording medium 14. Thus, at step S08, the PC 2 determines whether the third ID data obtained at step S07 is the data representing “***” Namely, upon determining that the third ID data is not the data representing “***,” the PC 2 determines that the second data differs from the third data (YES at step S08), and the process of the PC 2 proceeds to step S10. Whereas, upon determining that the third ID data is the data representing “***,” the PC 2 determines that the second data is the same as the third data (NO at step S08), and the process of the PC 2 proceeds to step S09.

(Example of Updating the Management Data (Step S09))

At step S09, the PC 2 updates the management data. Specifically, among the data items maintained in the management data described above (Table 3), the PC 2 reflects the result of the determination at step S08 to the data where the “ITNo” is “3,” for which the “second data” is “***.” For example, the management data that is updated by step S09 is as described below (Table 5).

TABLE 5

| | | | First | Second |
|---|---|---|---|---|
| ITNo | ID | Second data | calculated value | calculated value |
| 1 | aaa | | 40% | 10 times |
| 2 | bbb | | 60% | 100 times |
| 3 | *** | | 50% | 6 times |
| . | . | . | . | . |
| . | . | . | . | . |
| . | . | . | . | . |

The above-described Table 5 differs from the above-described Table 3 in the row where the “ITNo” is “3.” Specifically, in the row where the “ITNo” is “3,” the “ID” is updated from “ccc” to “***.” Additionally, in the above-described Table 5, in the row where the “ITNo” is “3,” the “second data” is deleted.

Additionally, in the above-described Table 5, the calculated values are updated. Specifically, for the “second calculated value,” the number of times of writing “***,” which is “1,” is added to the “second calculated value” of the above-described Table 3, which is “5.” Since “5+1=6,” the “second calculated value” is updated to be “6.”

Further, for the “first calculated value,” a ratio of the number of times that the second data differs from the third data at step S08, namely, the number of times of determining that writing has failed is calculated, and the “first calculated value” is updated. For example, in the above-described Table 3, the “first calculated value” corresponds to the case where, among five times of writing, three times of writing are determined to have failed at step S08. Thus, the “first calculated value” indicates “⅗=0.6=60%.” Whereas, in the above-described Table 5, the “first calculated value” reflects, among six times of writing, a number of times of determining, at step S08, that the second data does not differ from the third data, namely, a number of times of determining that the second data is the same as the third data and a determination is made that writing is successful. Namely, in the above-described Table 5, the “first calculated value” is updated to be “ 3/6=0.5=50%,” where the number of times of writing is “6,” and the number of times of determining that writing has failed is “3.”

Note that the method of calculating the “first calculated value” is not limited to the method of calculating based on the number of times of writing and the number of times of determining that writing has failed, as the above-described calculation formula. For example, the “first calculation value” may be calculated by further multiplying the correction coefficient, which is based on the elapsed time from the start of operating the information processing system 1 illustrated in FIG. 1.

The correction coefficient based on the elapsed time is described below.

In this example, the data described below (Table 6) is stored in the management data.

TABLE 6

| | | | First | Second | |
|---|---|---|---|---|---|
| | | Second | calculated | calculated | Operating |
| ITNo | ID | data | value | value | time |
| 1 | aaa | | 40% | 10 times | 20 hours |
| 2 | bbb | | 60% | 100 times | 1100 hours |
| 3 | ccc | | 60% | 5 times | 3 hours |
| . | . | . | . | . | . |
| . | . | . | . | . | . |
| . | . | . | . | . | . |

The above-described Table 6 differs from the above-described Table 5 in a point that the column of the “operating time” is added to the above-described Table 5. Namely, in this example, the “operating time” of each thermo-sensitive recording medium 14 is stored in the management data.

For example, in the above-described Table 6, for a case where the “ITNo” is “1,” the operating time is the time interval of using the thermo-sensitive recording medium 14 with the “ID” of “aaa.” Namely, the management data described above (Table 6) indicates that “20 hours” has elapsed from the time at which the thermo-sensitive recording medium 14 with the “ID” of “aaa” is attached to the container.

Here, the operating time is not limited to the above-described format (Table 6). For example, the operating time may be a time period or date and time for calculating the operating time. Specifically, the management data may store “date and time of attaching the thermo-sensitive recording medium 14 to the container.” In this case, the operating time is a time interval from the stored “date and time of attaching the thermo-sensitive recording medium 14 to the container” to the current data and time.

Furthermore, an example of a method of multiplying the correction coefficient is described below.

A recording medium tends to be degraded as time elapses. Thus, the service life of the recording medium may expire not only due to the number of times of writing by the writing device on the recording medium, but also due to the elapsed time.

Here, an example is described blow where the service life of the recording medium expires if the operating time exceeds “1000 hours.” Namely, an example is described where a threshold value is “1000” for the determination of the operating time. In the above-described example (Table 6), the “operating time” of the data item with the “ITNo” of “2” is “1100.” Thus, the data item with the “ITNo” of “2” corresponds to the case where the “operating time” exceeds the threshold value of “1000.” Note that the threshold value representing the predetermined value is input to the PC in advance. In this case, the PC 2 may evaluate that the service life of the thermo-sensitive recording medium 14 expires based on the operating time, even if the first calculated value does not exceed the threshold value.

In this manner, the correction coefficient may be used for detecting the service life of the thermo-sensitive recording medium 14 based on the operating time. For example, a calculation formula for evaluating the service life of the thermo-sensitive recording medium 14 may be as the formula (1) described below.

The first calculated value×(the operating time/1000 hours) (1)

Specifically, by applying the data item with the “ITNo” of “2” to the above-described formula (1), the service life of the thermo-sensitive recording medium 14 can be calculated as the formula (2) described below.

60%×(1100 hours/1000 hours)=66 (2)

In the above-described formula (1) and formula (2), the calculation result is obtained by multiplying the “first calculated value” with a ratio of exceeding the service life, namely, the radio of the “operating time” with respect to the threshold value. As shown in (2), if the operating time exceeds the threshold value, the radio of the “operating time” with respect to the threshold value becomes greater than “1.” Thus, the calculation result is greater than the “first calculated value.”

As described above, if the above-described formula (1) is used, the PC 2 can evaluate the service life of the thermo-sensitive recording medium 14, while considering the operating time of the thermo-sensitive recording medium 14. Specifically, for a case where the ratio of the number of times of determining that writing has failed is calculated, as described above (Table 5), first, evaluation is made where the ratio of the number of times of determining that writing has failed is compared with the threshold value. Then, in response to determining that the ratio of the number of times of determining that writing has failed exceeds the threshold value, the calculation result by the above-described formula (1) is further compared with the threshold value. Subsequently, if it is determined that the calculation result exceeds the threshold value in the result of the comparison between the calculation result by the above-described formula (1) and the threshold value, the PC 2 may evaluate that the service life of the thermo-sensitive recording medium 14 has expired. Whereas, if it is determined that the calculation result does not exceed the threshold value in the result of the comparison between the calculation result by the above-described formula (1) and the threshold value, the PC 2 may evaluate that the failure is caused by a reason other than the service life. Here, these results may be reported to an operator, for example.

Note that the calculation formula is not limited to the above-described formula (1). For example, a predetermined weighting factor may be multiplied to “1100 hours/1000 hours” in the above-described formula (1). In this manner, the weight of the operating time can be adjusted in the evaluation.

(Example of a Case where Writing is Successful)

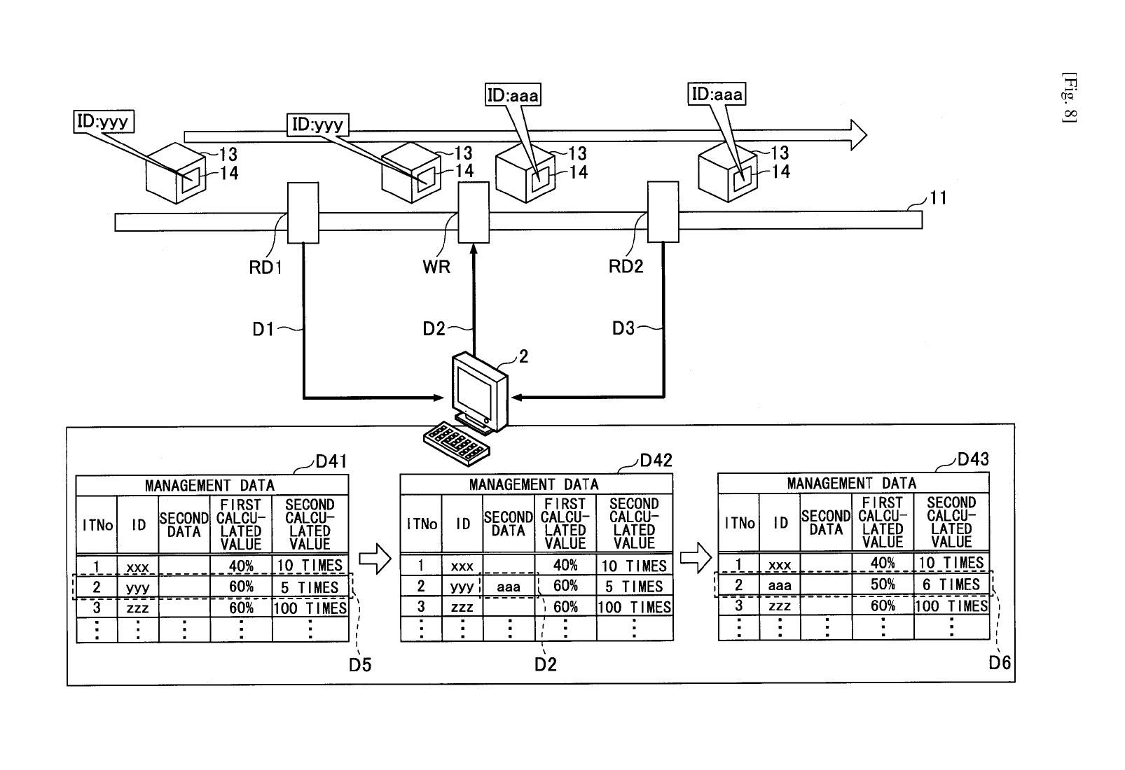

FIG. 8 is a diagram illustrating an example of a case where writing is successful in the whole process by the information processing system 1 according to the embodiment. Namely, FIG. 8 is the diagram illustrating an example of the case where writing on the thermo-sensitive recording medium 14 is successful (NO at step S08 of FIG. 7) in the whole process illustrated in FIG. 7.

FIG. 8 is an example where, based on the second ID data, the character indicating the ID of “aaa” is written on the thermo-sensitive recording medium 14 on which the character indicating the ID of “yyy” is written. Further, in FIG. 8, when the container 13 to which the thermo-sensitive recording medium 14 is attached is conveyed on the conveyor 11, and the container 13 reaches the position where the reader RD 1 is disposed, the process of step S01 (FIG. 7) is executed. Subsequently, in response to detecting that the container 13 is moved to a position where the laser writing device WR is disposed, the process of step S06 (FIG. 7) is executed. Subsequently, upon detecting that the container 13 is moved to a position where the reader RD 2 is disposed, the process of step S07 (FIG. 7) is executed. Further, in the example, the PC 2 stores, in advance, the first management data D41, which corresponds to the above-described Table 2.

Upon detecting that the container 13 is conveyed to the position where the reader RD 1 is disposed, the reader RD 1 executes reading, and the PC 2 obtains the first ID data D1 indicating “yyy” (step S01 of FIG. 7). Subsequently, the PC 2 identifies the thermo-sensitive recording medium 14 based on the first ID data D1 (step S02 of FIG. 7). In response to identifying the thermo-sensitive recording medium 14 based on the first ID data D1, the PC 2 searches for data D5 (which is referred to as the “recording medium data,” hereinafter) corresponding to the thermo-sensitive recording medium 14 in the data items included in first management data D41.

Subsequently, in order to register “aaa,” the PC 2 replaces the first management data D41 with second management data D42 (step S04 of FIG. 7). As depicted, in the second management data D42, the identified thermo-sensitive recording medium 14 is associated with the ID “aaa,” which is newly added, and the associated ID “aaa” is stored. Further, the PC 2 generates the second ID data D2 indicating “aaa” based on the second management data D42, and the PC 2 transmits the second ID data D2 to the laser writing device WR (step S05 of FIG. 7).

Subsequently, upon detecting that the container 13 is moved to the position where the laser writing device WR is disposed, the laser writing device WR deletes the character indicating the ID “yyy” on the thermo-sensitive recording medium 14. Then, the laser writing device WR writes the character indicating the ID “aaa” based on the second ID data D2 (step S06 of FIG. 7).

Subsequently, upon detecting that the container 13 is moved to the position where the reader RD 2 is disposed, the reader RD 2 reads the character indicating the ID of “aaa,” and the PC 2 obtains, as the third data, the third ID data D3 indicating “aaa” (step S07 of FIG. 7).

In FIG. 8, the third ID data D3 is identical to the second ID data D2. Thus, the PC 2 determines that the second data does not differ from (is the same as) the third data, and a determination is made that writing is successful (NO at step S08 of FIG. 7). Next, upon determining that writing is successful, the PC 2 updates the second management data D42 with the third management data D43 (step S09 of FIG. 7).

The third management data D43 is obtained by updating the update data D6 among the data items included in the second management data D42. FIG. 8 is the example where the laser writing device WR executes writing, and a determination is made that writing is successful. Thus, in the management data, the “second calculated value” indicating the number of times of writing is incremented by “1,” and the “first calculated value” indicating the ratio of the number of times of determining that writing has failed with respect to the number of times of writing is decreased.

Unlike the case of FIG. 8, it is possible that writing has failed. The case where writing has failed is a case where the PC 2 determines that the second data differs from the third data in the whole process illustrated in FIG. 7 (YES at step S08). The whole process illustrated in FIG. 7 is described below. Here, the whole process is executed if it is determined that writing has failed.

(Example of Updating the Management Data (Step S10))

At step S10, among the data items included in the management data described above (Table 3), the PC 2 updates the data with “ITNo” of “3” where the “second data” is “***,” based on the result of the determination at step S08. For example, the management data updated at step S10 is as described below (Table 7).

TABLE 7

| | | | First | Second |
|---|---|---|---|---|
| ITNo | ID | Second data | calculated value | calculated value |
| 1 | aaa | | 40% | 10 times |
| 2 | bbb | | 60% | 100 times |
| 3 | ccc | *** | 67% | 6 times |
| . | . | . | . | . |
| . | . | . | . | . |
| . | . | . | . | . |

In the above-described Table 7, the calculated values are updated. By comparing Table 3 with Table 7, it can be seen that the calculated values are different. Specifically, at step S10, similar to the case of the above-described Table 5, for the “second calculated value,” “1” is added to “5,” which is the previous “second calculated value,” and the “second calculated value” is updated to be “6” because “5+1=6.”

The “first calculated value” is updated to be the ratio of the number of times of determining that writing has failed with respect to the number of times of writing, which is “6.” For example, in the above-described Table 3, the “first calculated value” indicates the ratio of the number of times of determining that writing has failed, which is “3,” with respect to the number of times of writing, which is “5,” i.e., “⅗=0.6=60%.” In the above-described Table 7, the “first calculated value” is updated, so as to reflect that the number of times of writing is updated to be “6” and the number of times of determining that writing has failed is incremented by “1.” Namely, in the above-described Table 7, the “first calculated value” indicates the ratio of the number of times of determining that writing has failed, which is “3+1=4,” with respect to the number of times of writing, which is “6.” Thus, in the above-described Table 7, the “first calculated value” is “ 4/6=0.67=67%.”

Here, if the ratio of the number of times of determining that writing is successful with respect to the number of times of writing is used as the “first calculated value,” the “first calculated value” is calculated as “ 2/6=0.33=33%,” where the number of times of writing is “6” and the number of times of determining that writing is successful is “2.” Here, the ratio of the number of times of determining that writing is successful with respect to the number of times of writing may be calculated as “100%−67%=33%, based on the ratio of the number of times of determining that writing has failed with respect to the number of times of writing, which is “67%.”

(Example of Determining Whether the Calculated Value is Greater than or Equal to the Threshold Value (Step S11))

At step S11, the PC 2 determines whether the calculated value is greater than or equal to the threshold value. Specifically, at step S11, the PC 2 compares a predetermined threshold value with the “first calculated value,” which is described above (Table 7). For example, suppose that, as the predetermined value, the threshold value is set to “70%.” In this setting, the “first calculated value” of “67%” in the above-described Table 7 is less than “70%,” which is the threshold value. Thus, at step S11, the PC 2 determines, for the “first calculated value” in the above-described Table 7, that the calculated value is less than or equal to the threshold value (No at step S11).

However, after the management data is updated, at step S10, to be the data of Table 8, which is described below, the “first calculated value” of “83%” in Table 8 is greater than the threshold value, which is “70%.” Thus, at step S11, the PC 2 determines, for the “first calculated value” in Table 8, that the calculated value exceeds the threshold value (YES at step S11).

Here, if the ratio of the number of times of determining that writing is successful with respect to the number of times of writing is used as the “first calculated value,” the PC 2 determines, at step S11, whether the calculated value is less than or equal to the threshold value. Specifically, the PC 2 compares a predetermined threshold value with the “first calculated value,” which indicates the ratio of the number of times of determining that writing is successful with respect to the number of times of writing. In this case, the threshold value is set to “100%-70%=30%,” which corresponds to the above-described “70%.” In this setting, if the “first calculated value” is “33%,” the “first calculated value” is greater than “30%,” which is the threshold value. Thus, at step S11, the PC 2 determines that the calculated value is greater than the threshold value. This corresponds to the case where the ratio of the number of times of determining that writing has failed with respect to the number of times of writing is used as the “first calculated value,” and the PC 2 determines that the calculated value is less than or equal to the threshold value (NO at step S11).

TABLE 8

| | | | First | Second |
|---|---|---|---|---|
| ITNo | ID | Second data | calculated value | calculated value |
| 1 | aaa | | 40% | 10 times |
| 2 | bbb | | 60% | 100 times |
| 3 | ccc | *** | 83% | 6 times |
| . | . | . | . | . |
| . | . | . | . | . |
| . | . | . | . | . |

Here, the process at step S11 is an example of evaluating the thermo-sensitive recording medium 14 based on the calculated value. Namely, if it is determined that the calculated value exceeds the threshold value (YES at step S11) the PC 2 evaluates that the service life of the thermo-sensitive recording medium 14 expires. Whereas, if it is determined that the calculated value is less than or equal to the threshold value (NO at step S11), the service life of the thermo-sensitive recording medium 14 has not expired. Thus, the PC 2 evaluates that it is possible to continue writing on the thermo-sensitive recording medium 14.

Alternatively, the evaluation may be made, for example, by using the “second calculated value,” which is described in Table 7 and Table 8. Specifically, the threshold value is set to “1000 times,” for example. In this example of the evaluation, the “second calculated value” described in Table 7 is “6 times,” and the “second calculated value” is less than “1000 times,” which is the threshold value. Thus, at step S11, the PC 2 determines, for the “second calculated value” in Table 7, that the calculated value is less than or equal to the threshold value (NO at step S11). However, if the the “second calculated value” is “1001 times,” for example, the “second calculated value” is greater than “1000 times,” which is the threshold value. Thus, at step S11, the PC 2 determines, for the “second calculated value” of “1001 times,” that the calculated value exceeds the threshold value (YES at step S11).

If, for the thermo-sensitive recording medium 14, the number of times of writing exceeds a predetermined number of times, a failure tends to occur such that even if the written character is attempted to be deleted, the written character is not completely deleted. Here, the predetermine number of times may be 1000 times, for example. However, the predetermined number of times may be adjusted depending on the type (specification) of the thermo-sensitive recording medium 14. Thus, by executing the evaluation based on the number of times of writing, a failure where the written character is not completely deleted can be prevented from occurring.

Additionally, the management data may store data related to the container 13. In this case, the management data is as described below (Table 9), for example.

TABLE 9

| | | | First | Second | Con- | Number of |
|---|---|---|---|---|---|---|
| | | Second | calculated | calculated | tainer | times of using |
| ITNo | ID | data | value | value | ID | container |
| 1 | aaa | | 40% | 10 times | ddd | 30 times |
| 2 | bbb | | 60% | 100 times | eee | 120 times |
| 3 | ccc | *** | 83% | 6 times | fff | 1 time |
| . | . | . | . | . | . | . |
| . | . | . | . | . | . | . |
| . | . | . | . | . | . | . |

In the above-described Table 9, the management data includes, in addition to the data items of Table 8, the “container ID” and the “number of times of using the container.”

The “container ID” represents the ID for identifying the container 13.

The “number of times of using the container” is the number of times that the container 13 is used. Similar to the number of times of writing, after writing once, the “number of times of using the container” is incremented by “1,” for example.

If it is evaluated that the service life of the container 13 expires, the thermo-sensitive recording medium 14 attached to the container 13 is removed, and the removed thermo-sensitive recording medium 14 is attached to another container 13 by an operator, for example. At this time, the “container ID” and the “number of times of using the container” are updated, so that the “container ID” and the “number of times of using the container” correspond to the new container 13.

Thus, by storing, similar to the case of the “first calculated value,” the data related to the container 13, such as the “container ID” and the “number of times of using the container,” while associating the data with the “ID,” management of the container 13 can be facilitated in the information processing system 1. For example, for the “number of times of using the container,” evaluation may be made at step S11, similar to the case of the “second calculated value.”

The service life of the container 13 often differs from the service life of the thermo-sensitive recording medium 14. Thus, the timing at which the service life of the container 13 expires differs from the timing at which the service life of the thermo-sensitive recording medium 14 expires. In this manner, it is possible to manage the container 13, separately from the thermo-sensitive recording medium 14, based on the number of times of using the container 13. For example, it is possible to evaluate whether the service life of the container 13 expires, based on the number of times of using the container 13.

Additionally, evaluation may be made based on a calculated value of a ratio of the number of times of determining that the second data differs from the third data with respect to the most recent predetermined number of times of the number of times of writing. An example is described below where the most recent predetermined number of times is “5 times.” In this case, the management data further includes the data items, which are described below (Table 10). Here, the data items described below (Table 10) are associated with the thermo-sensitive recording medium 14. For each thermo-sensitive recording medium 14, the associated data items are stored. Specifically, Table 10 is an example of data related to “6 times” of writing, which corresponds to the data with “ITNo” of “3” in Table 8.

TABLE 10

| Number of times | Success/Fail |
|---|---|
| 1 | ◯ |
| 2 | ◯ |
| 3 | X |
| 4 | X |
| 5 | X |
| 6 | X |

The “number of times” is a serial number for identifying the number of times of writing. It is assumed that “1” represents the old data, and that “6” represents the newest data. Namely, the “most recent 5 times” correspond to the data with the “number of times” in a range from “2” to “6” in Table 10.

In the column of the “Success/Fail,” the case where writing is successful (NO at step S08) is indicated by “◯,” and the case where writing has failed (YES at step S08) is indicated by “x.”

In Table 10, in the “most recent 5 times,” the number of times of “x” is 4 times. Thus, the PC 2 calculates the calculated value as “⅘=0.8=80%.” Subsequently, if the threshold value is “70%,” the PC 2 determines, at step S11, that the calculated value exceeds the threshold value (YES at step S11).

When the service life of the thermo-sensitive recording medium 14 almost expires, the thermo-sensitive recording medium 14 tends to fail, and writing tends to fail. Thus, if evaluation is made based on the calculated value of the ratio of the number of times of determining that the second data differs from the third data with respect to the most recent predetermined number of times, the PC 2 can accurately evaluate the service life of the thermo-sensitive recording medium 14.

Additionally, evaluation may be made based on whether determinations are continuously made that the second data differs from the third data. An example is described below where determinations are continuously made three times. Specifically, in Table 10, for the three “number of times” from “4” to “6,” the values of the column of the “Success/Fail” are “x.” Namely, writing has continuously failed three times. In this case, at step S11, the PC 2 determines that the calculated value exceeds the threshold value (YES at step S11).

If it is detected that writing on the thermo-sensitive recording medium 14 has continuously failed, it is likely that the thermo-sensitive recording medium 14 has failed. Thus, if evaluation is made based on whether determinations are continuously made that the second data differs from the third data, the PC 2 can accurately evaluate the service life of the thermo-sensitive recording medium 14.

Further, at step S11, evaluation may be made by combining a plurality of calculated values. For example, for each of the “first calculated value” and the “second calculated value,” the PC 2 may execute the determination at step S11 based on the corresponding calculated value. Further, upon determining that one of the “first calculated value” and the “second calculated value” exceeds the threshold value, the PC 2 determines that the calculated value exceeds the threshold value (YES at step S11). Furthermore, upon determining that the both the “first calculated value” and the “second calculated value” exceed the corresponding threshold values, the PC 2 may determine that the calculated value exceeds the threshold value (YES at step S11). By executing evaluation by combining the plurality of calculated values, the PC 2 can be accurately evaluate the service life of the thermo-sensitive recording medium 14.

Next, upon determining, by the PC 2, that the calculated value exceeds the threshold value (YES at step S11), the process of the PC 2 proceeds to step S12. Whereas, upon determining, by the PC 2, that the calculated value is less than or equal to the threshold value (NO at step S11), the process of the PC 2 proceeds to step S13.

(Example of Reporting the Expiration of the Service Life (Step S12))

At step S12, the PC 2 reports that the service life of the thermo-sensitive recording medium 14 expires. Specifically, at step 12, the PC 2 reports to an operator that the service life of the thermo-sensitive recording medium 14 expires by displaying a message on the display 120 (FIG. 5), for example. Here, the massage may be, for example, characters representing an instruction to replace the thermo-sensitive recording medium 14, reassembly of the container 13, removal of the container 13, or combination there of.

After the container is removed in accordance with the report, the information processing system 1 may prompt an operator to place another container 13, and the information processing system 1 may execute writing with respect to the newly introduced container 13. Further, if a writing device is installed at a downstream position, the information processing system 1 may instruct the writing device installed at the downstream position to execute writing with respect to the newly introduced container 13.

(Example of Reporting that the Writing Device Further Executes Writing (Step S13))

At step S13, the PC 2 reports to the writing device that writing on the thermo-sensitive recording medium 14 is further executed.

(Example of a Case where Writing is Failed)

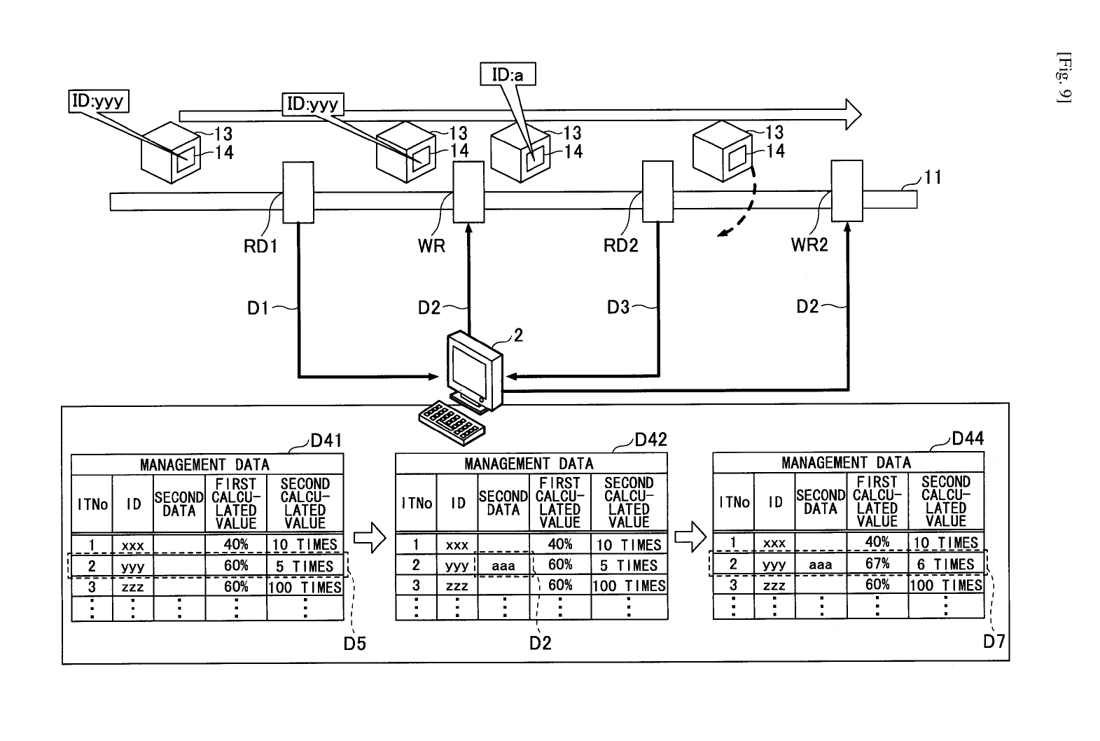

FIG. 9 is a diagram illustrating an example of a case where writing has failed in the whole process of the information processing system 1 according to the embodiment. Namely, FIG. 9 illustrates an example where, in the whole process of FIG. 7, writing on the thermo-sensitive recording medium 14 has failed (YES at step S08 of FIG. 7).

Similar to FIG. 8, FIG. 9 illustrates the example where, based on the second ID data, the character representing the ID of “aaa” is written on the thermo-sensitive recording medium 14 on which the ID of “yyy” is written. In FIG. 9, the process from reading by the reader RD 1 (step S01 of FIG. 7) to writing by the laser writing device WR (step S06 of FIG. 7) is the same as the process of FIG. 8. Thus, the description of the process is omitted. The points that are different from FIG. 8 are mainly described below.

During writing by the laser writing device WR, it is possible that the conveyor 11 oscillates. Additionally, if the service life of the thermo-sensitive recording medium 14 expires or the container 13 is deformed, the laser writing device WR may not write a part of or all the character representing “aaa.” An example is described below where the laser writing device WR writes, on the thermo-sensitive recording medium 14, only the character representing “a,” which is a part of the character representing “aaa.”

Upon detecting that the container 13 is moved to the position where the reader RD 2 is disposed, the reader RD 2 executes reading, and the PC 2 obtains, as the third data, the third ID data D3 representing “a” (step S07 of FIG. 7).

The third ID data D3 represents “a.” In contrast, the second ID data D2 represents “aaa.” Thus, the PC 2 determines that the second data differs from the third data, and the PC 2 determines that writing has failed (YES at step S08 of FIG. 7). Upon determining that writing has failed, the PC 2 updates the second management data D42 to be fourth management data D44 (step S10 of FIG. 7).

The fourth management data D44 is obtained by updating, among the data items included in the second management data D42, the update data D7. In FIG. 9, writing is executed and writing has failed. Thus, the “second calculated value,” which represents the number of times of writing, is incremented by “1,” and the “first calculated value,” which represents the ratio of the number of times of determining that writing is failed with respect to the number of times of writing, is increased.

For the container 13 for which a determination is made that writing has failed, a process is executed later, which depends on the evaluation based on the calculated value. The container 13 for which a determination is made that writing has failed is removed from the conveyor 11 by an operator, for example. Subsequently, if it is evaluated that the service life of the container 13 expires (YES at step S11 of FIG. 7), the operator reassembles or replaces the container 13, for example. Further, if it is evaluated that the service life of the thermo-sensitive recording medium 14 expires (YES at step S11 of FIG. 7), the operator replaces the thermo-sensitive recording medium 14 with a new thermo-sensitive recording medium 14, for example.

If it is determined that the service life of the container 13 expires or the service life of the thermo-sensitive recording medium 14 expires, it is likely that a failure occurs. Thus, even if the writing device further executes writing, it is likely that writing will fail. Thus, it is desirable that the container 13, the thermo-sensitive recording medium 14, or both the container 13 and the thermo-sensitive recording medium 14 are replaced. Whereas, if it is determined that the service life of the container 13 does not expire or the service life of the thermo-sensitive recording medium 14 does not expire, it is likely that writing has failed due to the oscillation of the conveyor 11. Thus, if the writing device executes writing again, it is likely that writing is successful.

Thus, as described below (Table 11), the PC 2 prompts the laser writing device WR to execute writing based on the second data of “***,” writing of which has failed. Here, the second data of “***” is indicated in the row with “ITNo” of “3” in Table 8.

TABLE 11

| | | | | | |
|---|---|---|---|---|---|
| RQNo | 1 | 2 | 3 | . . . | N |
| ITNo | | | 3 | . . . | |

For example, as described above (Table 11), the second data with the “ITNo” of “3” is transmitted to the laser writing device WR. In this case, it is assumed that the container 13 is placed again on the conveyor 11, so that the container 13 is moved to the position where the laser writing device WR is disposed at a timing at which third writing is executed. Namely, the above-described (Table 11) data is for managing a re-inputting process that is executed at step S20, as described above.

A laser writing device WR 2 may be installed at a downstream position of the laser writing device WR. In this case, the PC 2 may transmit the second ID data D2 to the laser writing device WR 2 in synchronization with the timing at which the container 13 is moved to the position where the laser writing device WR 2 is disposed.

(Example of Re-Inputting Process (Step S20))

Referring back to FIG. 7, at step S20, the PC 2 executes the re-inputting process.

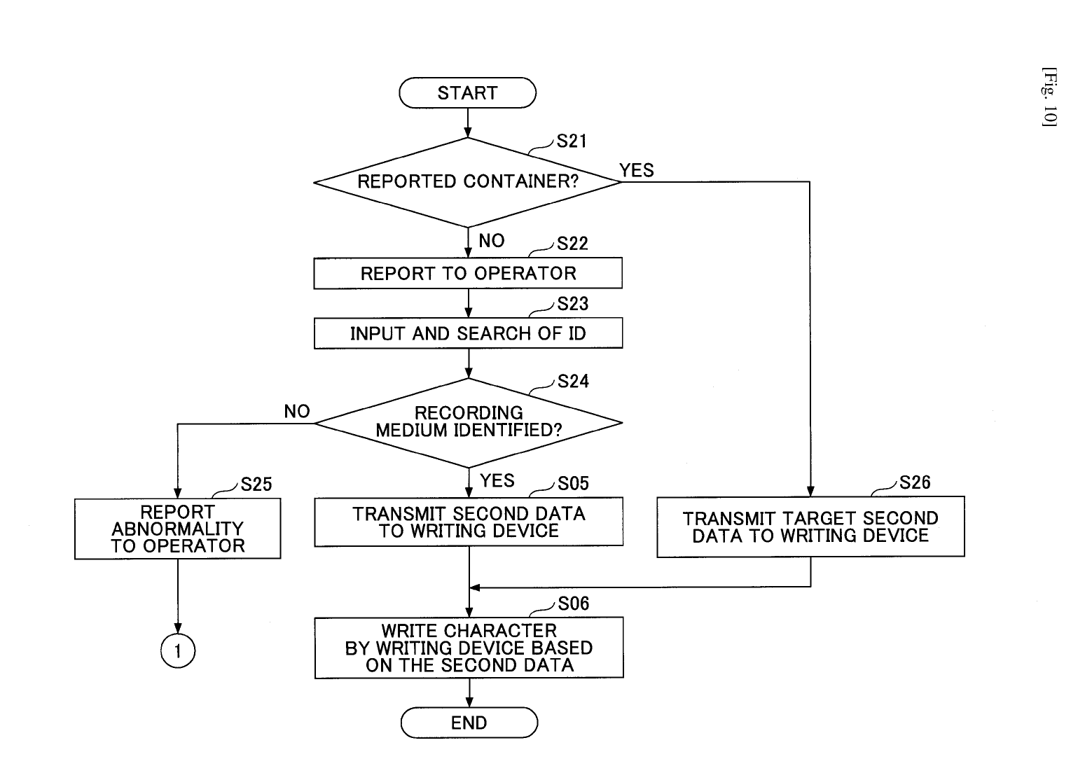

FIG. 10 is a flowchart illustrating an example of the re-inputting process executed by the information processing system 1 according to the embodiment. Note that, in the process illustrated in FIG. 10, a determination is made as to whether the container 13 is the container 13 reported at step S13 of the whole process of FIG. 7, and a process depending on the result of the determination is to be executed. Further, in FIG. 10, for the processes that are the same as the processes of FIG. 7, the same reference numerals are attached, and the description of the processes is omitted.

(Example of Determining Reported or not (Step S21))

At step S21, the PC 2 determines whether reporting at step S13 (FIG. 7) is executed. Specifically, if it is determined that reporting at step S13 is executed (YES at step S21), the process of the PC 2 proceeds to step S26. Whereas, if it is determined that reporting at step S13 is not executed (NO at step S21), the process of the PC 2 proceeds to step S22.

(Example of Reporting to the Operator (Step S22))

At step S22, the PC 2 reports to the operator. Specifically, at step S22, the PC 2 prompts the operator to input the ID.

If a part of or all the thermo-sensitive recording medium 14 is damaged or stained, the reader RD 1 (FIG. 1) may not read the character representing the ID. Thus, the PC 2 prompts the operator to read the ID by visual observation, and to input the read ID by using the keyboard 107 (FIG. 5). Here, if the part of or all the thermo-sensitive recording medium 14 is damaged or stained, and the operator may not read the ID by visual observation, the operator may input information, such as information indicating that “it is not possible to read the ID.”

(Example of Obtaining and Searching for the ID (Step S23))

At step S23, the PC 2 obtains data representing the ID input at step S22, and similar to step S02 (FIG. 7), the PC 2 searches for the ID that is the same as the ID represented by the obtained ID, among “IDs” of Table 2.

(Example of Determination as to Whether the Recording Medium is Identified (Step S24))

At step S24, the PC 2 determines whether the thermo-sensitive recording medium 14 is identified. Here, the process of the determination is the same as the process at step S03 of FIG. 7, for example.

Subsequently, if it is determined that the thermo-sensitive recording medium 14 is identified (YES at step S24), the process of the PC 2 proceeds to step S05. Whereas, if it is determined that the thermo-sensitive recording medium 14 is not identified (NO at step S24), the process of the PC 2 proceeds to step S25.

Note that, at step S05 and step S06, the second data is transmitted to the laser writing device WR, and the laser writing device WR executes writing. Details are the same as the process that is executed in the whole process of FIG. 7. Thus, the description of the process is omitted.

(Example of Reporting Abnormality to the Operator (Step S25))

At step S25, upon detecting, by the PC 2, that there is a thermo-sensitive recording medium 14 with an ID that is not included in Table 2, the PC 2 reports to the operator that the input by the operator is incorrect, or that an abnormal state occurs, such as system trouble.

(Example of Transmitting the Second Data to the Writing Device (Step S26))

At step S26, the PC 2 transmits, to the laser writing device WR, the second data to be written on the target thermo-sensitive recording medium 14, among the data items described above (Table 11).

### Another Embodiment

Another embodiment can be implemented, for example, by the information processing system 1, which is illustrated in FIG. 1. Thus, details of the description of the information processing system 1 and the devices included in the information processing system 1 are omitted. The whole process of this embodiment differs from the whole process of the above-described embodiment.

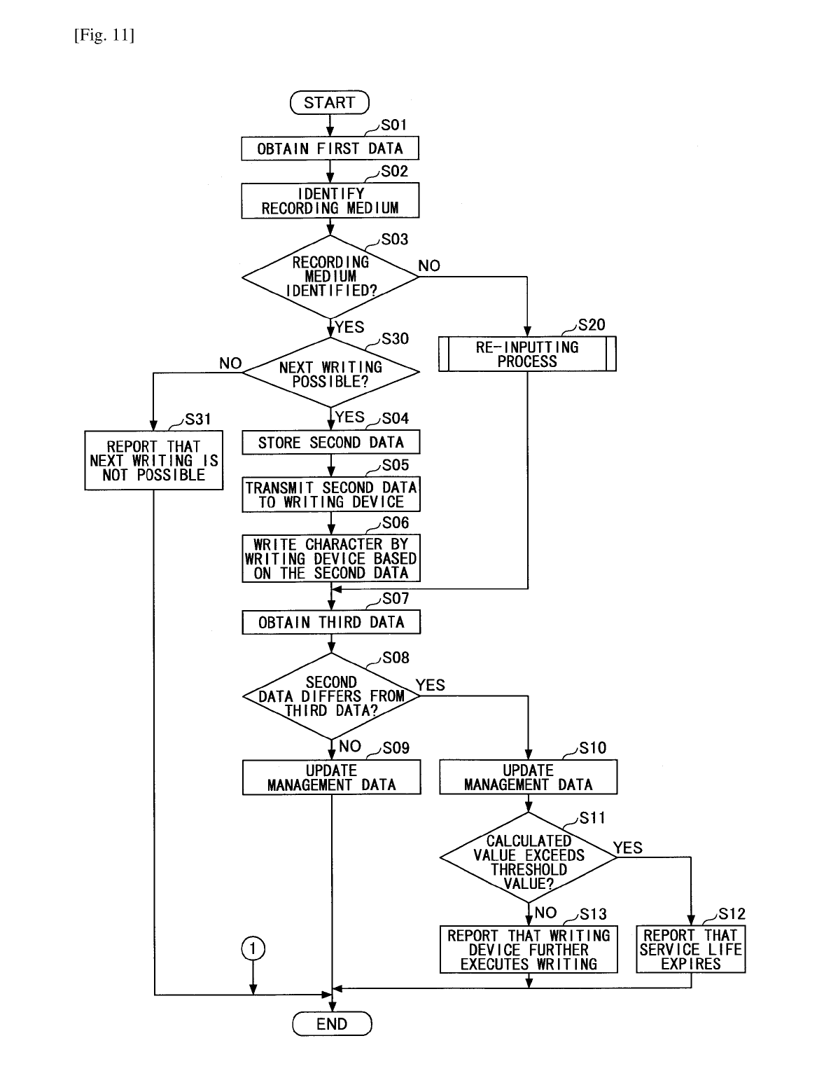

FIG. 11 is a flowchart illustrating an example of the whole process by the information processing system 1 according to this embodiment. In FIG. 11, the same reference numerals are attached to the processes that are same as the processes of FIG. 7, and thereby the description of the processes is omitted. The points that are different from FIG. 7 are mainly described below.

The whole process of FIG. 11 differs from the whole process of FIG. 7 in a point that, if the thermo-sensitive recording medium 14 is identified at step S03 (YES at step S03), the process at step S30 is to be executed. Namely, in this embodiment, the PC 2 determines whether the next writing is possible, prior to executing writing.

(Example of Determining Whether the Next Writing is Possible (Step S30))

At step S30, the PC 2 determines whether the next writing is possible. Specifically, similar to step S09, the PC 2 updates the management data. For example, the PC 2 updates the “second calculated value” of Table 3 by adding “1,” which corresponds to the next writing, to the “second calculated value” of Table 3. Subsequently, similar to step S11, the PC 2 determines whether the updated calculated value exceeds the threshold value.

Specifically, the PC 2 compares the predetermined threshold value with the updated “second calculated value.” Namely, at step S30, the PC 2 determines whether the number of times of writing exceeds the threshold value, while assuming that the next writing is executed.

In response to determining that the updated calculated value exceeds the threshold value, the PC 2 determines that the next writing is not possible. Whereas, upon determining that the updated calculated value is less than or equal to the threshold value, the PC 2 determines that the next writing is possible. In response to determining, by the PC 2, that the next writing is not possible (NO at step S30), the process of the PC 2 proceeds to step S31. Whereas, upon determining, by the PC 2, that the next writing is possible (YES at step S30), the process of the PC 2 proceeds to step S04.

(Example of Reporting that the Next Writing is not Possible (Step S31))

At step S31, the PC 2 reports that the next writing is not possible. Specifically, at step S31, the PC 2 reports in a similar manner as step S12, for example.

By determining, prior to executing writing, whether the next writing is possible, the PC 2 can predict, prior to executing writing, whether it is likely that the next writing will fail.

(Example of Functional Configuration)

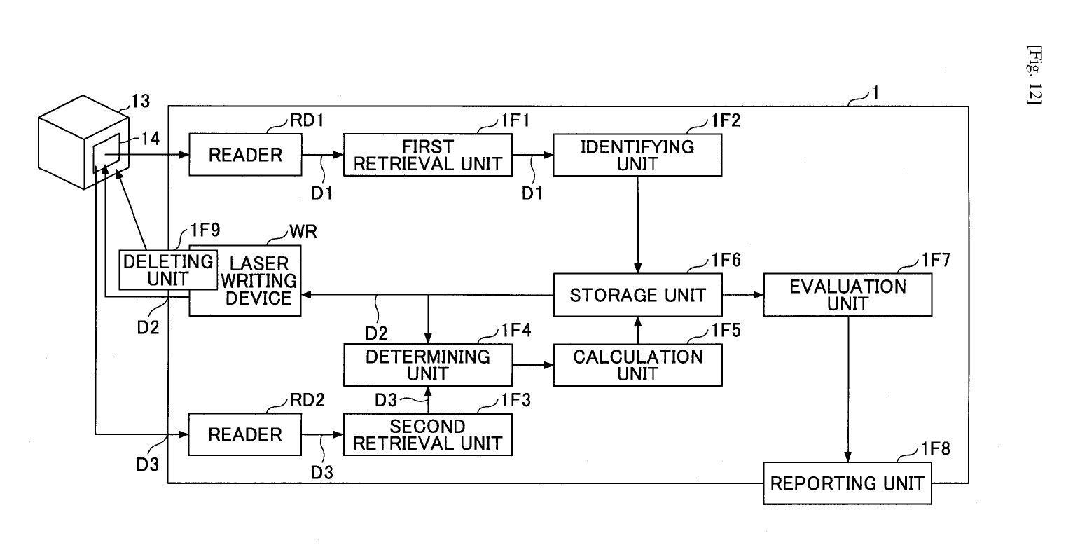

FIG. 12 is a functional block diagram illustrating an example of a functional configuration of the information processing system 1 according to the embodiment.

Specifically, the information processing system 1 includes a first retrieval unit 1F1; an identifying unit 1F2; a second retrieval unit 1F3; a determining unit 1F4; a calculation unit 1F5; a storage unit 1F6; an evaluation unit 1F7; a reporting unit 1F8; and a deleting unit 1F9. Additionally, the information processing system 1 includes the reader RD 1; the laser writing device WR; and the reader RD 2.

The first retrieval unit 1F1 obtains the first ID data D1, which represents an ID for identifying the thermo-sensitive recording medium 14 attached to the container 13, from the reader RD 1. Here, the first retrieval unit 1F1 may be implemented, for example, by the network I/F 105 (FIG. 5).

The identifying unit 1F2 identifies the thermo-sensitive recording medium 14 based on the first ID data D1, which is obtained by the first retrieval unit 1F1. The identifying unit 1F2 may be implemented, for example, by the CPU 101 (FIG. 5).

In response to detecting that the laser writing device WR writes on the thermo-sensitive recording medium 14 based on the second ID data D2, the second retrieval unit obtains, from the reader RD 2, the third ID data D3 that represents the ID, which is written on the thermo-sensitive recording medium 14. The second retrieval unit IF3 may be implemented, for example, by the network I/F 105.

The determining unit 1F4 determines whether the second ID data D2 differs from the third ID data D3. The determining unit 1F4 may be implemented, for example, by the CPU 101.

The calculation unit 1F5 calculates a number of times of writing on the thermo-sensitive recording medium 14, such as the “second calculated value,” which is described above (Table 2). Additionally, the calculation unit 1F5 calculates a ratio of a number of times of determining, by the determining unit 1F4, that the second ID data D2 differs from the third ID data D3 with respect to the number of times of writing. The ratio may be the “first calculated value,” for example. The calculation unit 1F5 may be implemented, for example, by the CPU 101.

The storage unit 1F6 associates the thermo-sensitive recording medium 14 identified by the identifying unit 1F2 with the calculated value calculated by the calculation unit 1F5; and the storage unit 1F6 stores the associated calculated value as illustrated in Table 2. The storage unit 1F6 may be implemented, for example, by the HDD 104 (FIG. 5).

The evaluation unit 1F7 evaluates whether the service life of the thermo-sensitive recording medium 14 expires, based on the calculated value stored in the storage unit 1F6. Additionally, the evaluation unit 1F7 may evaluate whether the service life of the container 13 expires. The evaluation unit 1F7 may be implemented, for example, by the CPU 101.

The reporting unit 1F8 reports the result of the evaluation by the evaluation unit 1F7 to an operator. The reporting unit 1F8 may be implemented, for example, by the graphic board 106 (FIG. 5).

The deleting unit 1F9 deletes a text that is written on the thermo-sensitive recording medium 14. The deleting unit 1F9 may be implemented, for example, by the laser writing device WR.

In the information processing system 1, in response to detecting that the first ID data D1 is obtained by the first retrieval unit 1F1, the identifying unit 1F2 identifies the thermo-sensitive recording medium 14 and the container 13 by the ID, which is indicated by the first ID data D1. Then, in response to detecting that the thermo-sensitive recording medium 14 and the container 13 are identified, the storage unit 1F6 associates the thermo-sensitive recording medium 14 and the container 13 with the calculated value, which is calculated by the calculation unit 1F5; and the storage unit 1F6 stores the associated calculated value as described above (Table 2).

Additionally, by calculating a number of times of writing by the laser writing device WR, the storage unit 1F6 can associate the number of times of writing, as the calculated value, with the thermo-sensitive recording medium 14; and the storage unit 1F6 can store the associated number of times of writing. Furthermore, upon detecting that the laser writing device WR executes writing, in the information processing system 1, the second retrieval unit 1F3 obtains, from the reader RD 2, the third ID data D3. Subsequently, in the information processing system 1, the determining unit 1F4 determines whether the second ID data D2 stored in the storage unit 1F6 differs from the obtained third ID data D3.

The determining unit 1F4 determines whether writing is successful or has failed. For example, the calculation unit 1F5 calculates the number of times of determining that writing has failed; and the calculation unit 1F5 calculates a ratio of the number of times of determining that writing has failed with respect to the number of times of writing. Thus, the calculation unit 1F5 can calculate, for each thermo-sensitive recording medium 14 and container 13, a calculated value, such as the ratio of the number of times of determining that writing has failed with respect to the number of times of writing.

Further, in the information processing system 1, the thermo-sensitive recording medium 14 and the container 13 correspond to the calculated value. Thus, by comparing the calculated value with a threshold value, a determination may be made as to whether the service life of the thermo-sensitive recording medium 14 expires, and as to whether the service life of the container 13 expires.

For example, a Radio Frequency Identification (RFID) may often include a data area that is not erased, even if data is deleted. Thus, in many cases, the RFID may store a number of times that the RFID is used. Whereas, in the thermo-sensitive recording medium 14, during a deleting process by the deleting unit 1F9, the character that is written on the thermo-sensitive recording medium 14 tends to be deleted. Thus, even if the number of times of writing is written on the thermo-sensitive recording medium 14, upon executing the deleting process, the number of times of writing tends to be deleted. In many cases, it is not possible to maintain the data indicating the number of times of writing on the thermo-sensitive recording medium 14. Similarly, in many cases, the container 13 does not include a data area. For maintaining data indicating the number of times of using the container 13, a RFID may be attached to the container 13.

In contrast, in the information processing system 1 according to the embodiment of the present invention, the thermo-sensitive recording medium 14 is associated with the calculated value, and the associated calculated value is stored. Thus, the number of times of writing can be found, and it is possible to evaluate whether the service life of the thermo-sensitive recording medium 14 expires. Consequently, upon detecting, based on the evaluation, that the service life of the thermo-sensitive recording medium 14 expires, the information processing system 1 may report, to an operator, an instruction for replacing the thermo-sensitive recording medium 14, for example. In this manner, the information processing system 1 facilitates management of the recording medium.

Note that a part of or all the process of the embodiment of the present invention may be implemented by a program to be executed by a computer, which is described in a legacy programming language, such as assembler, C, C++, C#, and Java (registered trademark), or an object-oriented programming language. Namely, the program is a computer program for causing a computer, such as an information processing device or an information processing system including an information processing device, to execute each process.

Further, a program may be stored in a computer readable storage medium, such as a ROM or an Electrically Erasable Programmable ROM (EEPROM); and the program may be distributed by distributing the computer readable storage medium. Furthermore, the storage medium may be a Erasable Programmable ROM (EPROM), a flash memory, a flexible disk, a CD-ROM, a CD-RW, a DVD-ROM, a DVD-RAM, a DVD-RW, a Blue-ray disk, a SD (registered trademark) card, or a MO. Moreover, the program may be distributed through a telecommunication line.

Furthermore, the information processing system 1 may include two or more information processing devices that are mutually connected through a network. The plurality of information processing devices may execute a part of or all the process in a distributed manner, in a parallel manner, or in a redundant manner.

The information processing device, the information processing system, the information processing method, and the program for facilitating the management of the recording medium is described above by the embodiments. However, the present invention is not limited to the embodiments, and various modifications and improvements may be made within the scope of the present invention. Specific examples of numerical values are used in order to facilitate understanding of the invention. However, these numerical values are simply illustrative, and any other appropriate values may be used, except as indicated otherwise. The separations of the items in the above-described explanation are not essential to the present invention. Depending on necessity, subject matter described in two or more items may be combined and used, and subject matter described in an item may be applied to subject matter described in another item (provided that they do not contradict). A boundary of a functional unit or a processing unit in a functional block does not necessarily correspond to a boundary of a physical component. An operation by a plurality of functional units may be physically executed by a single component. Alternatively, an operation by a single functional unit may be physically executed by a plurality of components. For the convenience of explanation, the devices according to the embodiment of the present invention are explained by using the functional block diagrams. However, these devices may be implemented in hardware, software, or combinations thereof. The software that operates in accordance with the present invention may be prepared in any appropriate storage medium, such as a random access memory (RAM), a flash memory, a read-only memory (ROM), an EPROM, an EEPROM, a register, a hard disk drive (HDD), a removable disk, a CD-ROM, a database, a server, and the like.

The present invention can be implemented in any convenient form, for example using dedicated hardware, or a mixture of dedicated hardware and software. The present invention may be implemented as computer software implemented by one or more network processing apparatuses. The network can comprise any conventional terrestrial or wireless communications network, such as the Internet. The processing apparatuses can compromise any suitable programmed apparatuses such as a general-purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, a hard disk, a CD ROM, a magnetic tape device or a solid state memory device. The hardware platform includes any desired hardware resources including, for example, a central processing unit (CPU), a random access memory (RAM), and a hard disk drive (HDD). The CPU may include processors of any desired kinds and numbers. The RAM may include any desired volatile or non-volatile memories. The HDD may include any desired nonvolatile memories capable of recording a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The present application is based on and claims the benefit of priority of Japanese Patent Applications No. 2015-055415 filed on Mar. 18, 2015, and No. 2016-002694 filed on Jan. 8, 2016, the entire contents of which are hereby incorporated by reference.

### REFERENCE SIGNS LIST

1: INFORMATION PROCESSING SYSTEM
RD 1, RD 2: READER
WR, WR2: LASER WRITING DEVICE
13: CONTAINER
14: THERMO-SENSITIVE RECORDING MEDIUM
D1: FIRST ID DATA
D2: SECOND ID DATA
D3: THIRD ID DATA

### CITATION LIST

### Patent Literature

[PTL 1] Patent Document 1: Japanese Unexamined Patent Publication No. 2014-184713

1. An information processing device configured to connect to a first reading device configured to execute reading of a recording medium attached to a container to generate first data, a writing device configured to execute writing on the recording medium based on second data, and a second reading device configured to execute reading of the recording medium to generate third data, the information processing device comprising:
a first retrieval unit configured to obtain the first data;
an identifying unit configured to identify the recording medium based on the first data;
a second retrieval unit configured to obtain, upon detecting that the writing device executes writing on the recording medium based on the second data, the third data;
a determination unit configured to determine whether the second data differs from the third data;
a calculation unit configured to calculate a calculation value including a number of times of writing on the recording medium or a ratio of a number of times of determining, by the determining unit, that the second data differs from or is identical to the third data with respect to the number of times of writing;
a storage unit configured to store the calculation value, while associating the recording medium identified by the identifying unit with the calculation value; and
an evaluation unit configured to evaluate the recording medium based on the calculation value.

2. The information processing device according to claim 1,
wherein the writing device includes a deleting unit configured to delete a character, a number, a figure, a symbol, a barcode, a two-dimensional code, or a combination thereof, wherein the character, the number, the figure, the symbol, the barcode, the two-dimensional code, or the combination thereof is written on the recording medium.

3. The information processing device according to claim 1,
wherein the first data includes a first ID for identifying the recording medium, the second data includes a second ID for identifying the recording medium, and the third data includes a third ID for identifying the recording medium.

4. The information processing device according to claim 3,
wherein the information processing device is configured to store management data storing an ID that is written on the recording medium, and
wherein the identifying unit is configured to search for the first ID indicated by the first data in the management data to identify the recording medium.

5. The information processing device according to claim 1,
wherein the storage unit is configured to store operating time of the recording medium, and
wherein, upon detecting that a value obtained by multiplying the calculation value by a correction coefficient, the correction coefficient being calculated based on the operating time, exceeds a threshold value, the evaluation unit is configured to evaluate that a service life of the recording medium expires.

6. The information processing device according to claim 1,
wherein the calculation value is the ratio of the number of times of determining, by the determining unit, that the second data differs from the third data with respect to the number of times of writing, and
wherein, upon detecting that the calculation value exceeds a threshold value indicating a predetermined value, the evaluation unit is configured to evaluate that a service life of the recording medium expires.

7. The information processing device according to claim 1,
wherein the calculation value is the ratio of the number of times of determining, by the determining unit, that the second data is identical to the third data with respect to the number of times of writing, and
wherein, upon detecting that the calculation value is less than or equal to a threshold value indicating a predetermined value, the evaluation unit is configured to evaluate that a service life of the recording medium expires.

8. The information processing device according to claim 1,
wherein the calculation value is a ratio of, in a most recent predetermined number of times of the number of times of writing, a number of times of determining, by the determining unit, that the second data differs from the third data with respect to the most recent predetermined number of times, and
wherein, upon detecting that the calculation value exceeds a threshold value indicating a predetermined value, the evaluation unit is configured to evaluate that a service life of the recording medium expires.

9. The information processing device according to claim 1,
wherein the calculation value is a ratio of, in a most recent predetermined number of times of the number of times of writing, a number of times of determining, by the determining unit, that the second data is identical to the third data with respect to the most recent predetermined number of times, and
wherein, upon detecting that the calculation value is less than or equal to a threshold value indicating a predetermined value, the evaluation unit is configured to evaluate that a service life of the recording medium expires.

10. The information processing device according to claim 1,
wherein the calculation value is the number of times of writing, and
wherein, upon detecting that the calculation value exceeds a threshold value indicating a predetermined value, the evaluation unit is configured to evaluate that a service life of the recording medium expires.

11. The information processing device according to claim 1,
wherein the calculation value is the number of times of writing, and
wherein, upon detecting that determinations are continuously made, by the determining unit, a predetermined number of times that the second data differs from the third data, the evaluation unit is configured to evaluate that a service life of the recording medium expires.

12. The information processing device according to claim 1, further comprising:
a reporting unit configured to report a result of the evaluation.

13. The information processing device according to claim 1,
wherein the identifying unit is configured to identify the container corresponding to the identified recording medium,
wherein the calculation unit is configured to calculate a number of times of using the container, and
wherein the evaluation unit is configured to evaluate the container.

14. The information processing device according to claim 13,
wherein, upon detecting that the number of times of using the container exceeds a threshold value indicating a predetermined value, the evaluation unit is configured to evaluate that a service life of the container expires.

15. An information processing device configured to connect to a reading device configured to execute reading of a recording medium attached to a container to generate first data, and a writing device configured to execute writing on the recording medium, the information processing device comprising:
a first retrieval unit configured to obtain the first data;
an identifying unit configured to identify the recording medium based on the first data;
a calculation unit configured to calculate a calculation value including a number of times of writing for a case in which next writing is executed on the recording medium;
a storage unit configured to store the calculation value, while associating the recording medium identified by the identifying unit with the calculation value; and
an evaluation unit configured to evaluate the recording medium based on the calculation value.
